(19) United States
(12) Patent Application Publication
(10) Pub. No.: US 2012/0145120 A1
(43) Pub. Date: Jun. 14, 2012

(54) AXIAL-PISTON ENGINE, METHOD FOR OPERATING AN AXIAL-PISTON ENGINE, AND METHOD FOR PRODUCING A HEAT EXCHANGER OF AN AXIAL-PISTON ENGINE

(75) Inventors: Ulrich Rohs, Dueren (DE); Dieter Voigt, Aachen (DE)

(73) Assignee: Getas Gesellschaft Fuer thermodynamische Antriebssysteme mbh, Durene (DE)

(21) Appl. No.: 13/386,566

(22) PCT Filed: Jul. 26, 2010
(86) PCT No.: PCT/DE2010/000878

§ 371 Date: Jan. 23, 2012

(30) Foreign Application Priority Data
Jul. 24, 2009 (DE) 10 2009 034 737.2

(51) Int. Cl. F02B 53/00

(52) U.S. Cl. 123/204

(57) ABSTRACT

The aim of the invention is to improve the efficiency of an axial-piston motor. To this end, the axial-piston motor comprises at least one compressor cylinder, at least one working cylinder and at least one pressure line guiding the compressed fuel from the compressor cylinder to the working cylinder via a combustion chamber. The fuel flow from the combustion chamber to the working cylinder is controlled by at least one control piston driven by a control drive, and the control piston is subjected to a compensation force oriented against the combustion chamber pressure, on the side thereof facing away from the combustion chamber, in addition to the force applied by the control drive.

The invention relates on the one hand to an axial-piston engine. On the other hand, the invention relates to a method for operation of an axial-piston engine and to a method for production of a heat exchanger of an axial-piston engine.

Axial-piston engines are sufficiently known from the state of the art, and are characterized as energy-converting machines, which provide mechanical rotational energy on the output side with the aid of at least one piston, whereby the piston executes a linear oscillatory motion whose orientation is aligned essentially coaxially with the axis of rotation of the rotational energy.

In addition to axial piston engines that are operated, for example, only with compressed air, axial-piston engines to which a combustion agent is supplied are also known. This combustion agent can be made up of a plurality of components, for example a fuel and air, wherein the components are fed, together or separately, to one or more combustion chambers. In the present case, the term “combustion agent” thus designates any material that participates in the combustion, or is carried with components that participate in the combustion, and which flows through the axial-piston engine. The combustion agent then includes at least a combustible substance or fuel, whereby the term “fuel” in the present context describes any material that reacts exothermally by way of a chemical reaction or other reaction, in particular by way of a redox reaction. In addition, the combustion agent can also have components such as air, for example, which provide materials for the reaction of the fuel.

In particular, axial-piston engines can also be operated under the principle of internal continuous combustion (icc), according to which combustion agents, i.e., for example fuel and air, are fed continuously to a combustion chamber or to a plurality of combustion chambers.

Moreover, axial-piston engines can work on the one hand with rotating pistons, and correspondingly rotating cylinders, which are moved successively past a combustion chamber. On the other hand, axial-piston engines can have stationary cylinders, whereby the working medium is then successively distributed to the cylinders according to the desired loading sequence.

For example, icc axial-piston engines having stationary cylinders of this sort are known from EP 1 035 310 A2 and from WO 2009/062473 A2, whereby in EP 1 035 310 A2 an axial-piston engine is disclosed in which the supplying of combustion agent and the removal of exhaust gas are coupled with one another with heat exchange.

The axial-piston engines disclosed in EP 1 035 310 A2 and in WO 2009/062473 A2 have in addition a separation between working cylinders and the corresponding working pistons, and compressor cylinders and the corresponding compressor pistons, whereby the compressor cylinders are provided on the side of the axial-piston engine facing away from the working cylinders. In this respect, a compressor side and a working side can be assigned to such axial-piston engines.

It is understood that that the terms “working cylinder,” “working piston” and “working side” are used synonymously with the terms “expansion cylinder,” “expansion piston” and “expansion side” or “expander cylinder,” “expander piston” and “expander side,” as well as synonymously with the terms “expansion stage” or “expander stage,” whereby an “expander stage” or “expansion stage” designates the totality of all “expansion cylinders” or “expander cylinders” located therein.

The task of the present invention is to improve the efficiency of an axial-piston engine.

The task of the invention is accomplished by an axial-piston engine with at least one compressor cylinder, with at least one working cylinder and with at least one pressure line through which compressed combustion agent is conducted from the compressor cylinder via a combustion chamber to the working cylinder, wherein the stream of combustion agent from the combustion chamber to the working cylinder is controlled via at least one control piston, which is driven by a control drive, and wherein the axial-piston engine is characterized in that the control piston, in addition to the force applied by the control drive, is subjected on its side facing away from the combustion chamber to a compensating force directed counter to the combustion chamber pressure.

Advantageously, by means of such an additional compression force, sealing relative to the control piston can be substantially improved, wherein merely pure oil scraping ideally suffices for sealing relative to the combustion chamber or relative to a shot channel conducting the stream of combustion agent, so that sealing in this respect as known from International Patent Application WO 2009/062473 A2 is substantially simplified.

At this place it must be pointed out that especially the control drive can be diversely designed, for example as a hydraulic, electrical, magnetic or mechanical control drive.

It is particularly advantageous when the force applied by the control drive is different from the compensating force directed, according to the invention, counter to the combustion chamber pressure.

In general the entire control drive can be built substantially more compactly, since in essence it has to absorb only guide forces. Necessary forces exceeding this can, according to the invention, be applied by the compensating force, so that the control drive is not loaded or is loaded to only a negligible extent by forces for sealing relative to the control piston. In particular, this compensating force permits shorter control times, since both the control piston and the control drive can be of much more lightweight construction, since they are subjected to less load.

It is understood that such a compensating force can be applied in various ways by construction. To this end a preferred alternative embodiment provides that the compensating force is applied mechanically, for example via springs, since a mechanical arrangement can be structurally implemented very simply in the axial-piston engine.

Alternatively or cumulatively to this, it is advantageous when the compensating force is applied hydraulically, for example via oil pressure. Such an oil pressure can be supplied, for example, via an oil pump, especially also via a separate oil pump. The necessary oil pressure can be chosen in such a way that an oil pressure normally present in the axial-piston engine suffices for generation of the compensating force and can be used for this. However, a separate oil pump can also be provided.

With regard to a further alternative embodiment, it is provided that the compensating force is applied cumulatively or alternatively to this pneumatically, especially via the compressor pressure. This pneumatic variant has in particular the advantage that the pressure for generating the compensating force is present in any case in the axial-piston engine and in addition corresponds advantageously to approximately the combustion chamber pressure, since the actual work for generating the pressure is already performed in the working piston. In this respect, only slight sealing, which needs only a small pressure difference for sealing, need be provided. Supplementary to this, an oil pump can produce an appropriate oil film, wherein this then advantageously guides the oil in a separate circuit, wherein this oil pump is exposed to only a particularly low backpressure. In this respect, the oil pump then does not have to work against the compressor pressure, as will be explained in further detail in the following.

Advantageously the pneumatically generated compensating force can be generated by means of a provided combustion agent pressure of ca. 30 bar. To this end, especially the control space should be sealed appropriately from the atmosphere or from the other spaces of the axial-piston engine, so that only oil scraping is necessary for sealing between the combustion chamber or a corresponding shot channel and the control space. If necessary, a supplementary additional seal, albeit of appropriately smaller dimensions, may also be provided.

In this respect, a further accomplishment of the present task provides an axial-piston engine with at least one compressor cylinder, with at least one working cylinder and with at least one pressure line, through which compressed combustion agent is conducted from the compressor cylinder via a combustion chamber to the working cylinder, wherein the stream of combustion agent from the combustion chamber to the working cylinder is controlled via at least one control piston, which is driven by a control drive, and wherein the axial-piston engine is characterized in that the control piston is situated in a pressure space. This can be implemented in particular by the fact that the control space of the control chamber, and so the space in which the control piston and at least one part, preferably the essential parts, of the assemblies of the control drive are situated, is formed as a pressure space.

In this connection, the term “pressure space” denotes any enclosed space of the axial-piston engine that has a distinct overpressure relative to the environment, preferably at least 10 bar.

On the basis of the fact that the control piston is inherently situated in a pressure space, advantageously no complex sealing is necessary, so that work can be done with little losses from the axial-piston engine, whereby the efficiency of the axial-piston engine in turn can be improved. From the state of the art, it has previously been known only that the combustion chamber side but not the control piston is provided in a pressure space.

Furthermore, the task of the invention is also accomplished by an axial-piston engine with at least one compressor cylinder, with at least one working cylinder and with at least one pressure line, through which compressed combustion agent is conducted from the compressor cylinder via a combustion chamber to the working cylinder, wherein the stream of combustion agent from the combustion chamber to the working cylinder is controlled via at least one control piston, which is driven by a control drive, and wherein the axial-piston engine is characterized in particular in that the control drive includes a control shaft, which drives the control piston and cooperates with a shaft seal, which is subjected to compressor pressure on one side.

If the shaft seal is subjected to compressor pressure on one side, no further sealing is necessary in the ideal case, and the axial-piston engine can advantageously be operated with a smaller loss. The shaft seal then serves preferably as the seal for a pressure space of the axial-piston engine, which in particular can have the compressor pressure.

With an appropriately configured shaft seal, however, it is also possible to work with atmospheric pressure or with another engine pressure that is lower than the compressor pressure.

Furthermore, the task of the invention is accomplished by an axial-piston engine with at least one compressor cylinder, with at least one working cylinder and with at least one pressure line, through which compressed combustion agent is conducted from the compressor cylinder via a combustion chamber to the working cylinder, wherein the stream of combustion agent from the combustion chamber to the working cylinder is controlled via at least one control piston, which is driven by a control drive, and wherein the axial-piston engine is characterized in that the control drive piston is wetted with oil and the oil wetting the control piston is conducted in a separate oil circuit.

Certainly two oil pumps are necessary in order to be able to guide the oil wetting the control piston in a separate oil circuit. However, the oil pumps can work against different pressures. To this extent they can be operated with very low losses.

In the present connection, the term “separate” means that at least one further oil circuit exists for further components and/or component groups on the axial-piston engine.

In this respect, it is advantageous when the axial-piston engine includes a main oil circuit for lubrication and/or cooling of assemblies of the axial piston engine, which is separated from the separate oil circuit.

In order to be able to undertake a comparison or a check of the oil levels of the two oil circuits comfortably and precisely, it is of advantage when the axial-piston engine is characterized by an openable and closable connection between the main oil circuit and the separate oil circuit.

Depending on the concrete implementation of the present invention, the separate oil circuit and the compressor pressure can be matched to one another in such a way that together they supply the compensating pressure described above for buildup of the compensating force.

The axial-piston engine can be operated with even lower losses when the control piston is spray-cooled. Hereby the efficiency of the axial-piston engine can be further improved.

Cooling of the control piston in particular is achieved excellently even at extremely high working temperatures when the spray cooling takes place with oil.

In order to be able to prevent a critical loss of oil at the control piston, it is advantageous when an oil scraper is provided on the control piston. In particular, migration of oil into the shot channels and into the working cylinders can be prevented hereby.

Furthermore, in order to accomplish the task of the invention, alternatively or cumulatively, an axial-piston engine with a compressor stage comprising at least one cylinder, with an expander stage comprising at least one cylinder, with at least one combustion chamber between the compressor stage and the expander stage, with at least one component subjected to combustion chamber pressure and with an oil circuit for lubrication is proposed, wherein the oil circuit has an engine-oil circuit and a pressure-oil circuit with a pressure level different from the engine-oil circuit. Hereby, also corresponding to accomplishments of the task of the invention explained above, the advantage is implemented that, in a respective oil circuit with a different pressure level, the oil pump of that circuit, for example a pressure-oil pump of the pressure-oil circuit, has to apply only the backpressure needed for delivery of the oil, and that for achievement of a higher pressure, which may be necessary in this circuit for other reasons, exceeding that for conveying the oil, does not have to be applied by the pressure-oil pump.

By the fact that the pressure-oil circuit can have components that work against a combustion chamber pressure present in the combustion chamber, it is correspondingly advantageous when the pressure level of the pressure-oil circuit corresponds to the combustion chamber pressure. Alternatively or cumulatively to this, it can also be of advantage that the pressure level of the pressure-oil circuit corresponds to a compressor pressure. By a pressure level of the pressure-oil circuit corresponding to the combustion chamber pressure or to the compressor pressure, a gas force acting on a component subjected to combustion chamber pressure, for example on a control piston, can be largely compensated pneumatically. The task of further improving an axial-piston engine with respect to its efficiency is accomplished to the extent that a piston work acting on the control piston is minimized and thus the work or power output at the axial-piston engine is maximized for equal consumption of combustible substance.

In this connection, it must be pointed out that the phrase “the pressure level corresponds to a pressure” also tolerantly permits a pressure difference up to 40% between the pressure level and the pressure, whether it be the compressor pressure or the combustion chamber pressure. Preferably, however, a pressure difference of at most 7 bar is to be encompassed by the phrase “the pressure level corresponds to a pressure”. Such pressure differences can still be absorbed without too great efficiency losses of seals, which also withstand higher temperatures.

In order not to impede this efficiency-improving advantage for variable power output of the axial-piston engine, it is further proposed that the pressure-oil circuit have a pressure level higher than 20 bar at a full load of the axial-piston engine. Cumulatively or alternatively, it is proposed that the pressure-oil circuit have a pressure level between 5 bar and 20 bar during a partial load of the axial-piston engine. This ensures a balanced pressure ratio, by which the efficiency is optimized, for a large part of all operating situations. Alternatively or cumulatively to this, it is further proposed that the pressure-oil circuit have a pressure level below 5 bar during idling of the axial-piston engine and/or during standstill of the axial-piston engine. Particularly in these operating states, this permits a small load of the corresponding seals, so that even any leakage streams in particular, which could be active over a longer time period, have no substantial disturbing influences. The maintenance of a pressure in the pressure-oil circuit can be advantageous in particular when a stop-start system brings about a temporary standstill of the axial-piston engine and thus a pressure does not have to be newly built up in the pressure-oil circuit after a start of the axial-piston engine, since this pressure can be maintained even during a temporary standstill. In a load-dependent and unstationary operation of the axial-piston engine, it is possible, by the measures explained above, to implement in particular the advantage that compensation of the combustion chamber pressure at a component subjected to combustion chamber pressure always corresponds to the combustion chamber pressure or to the load point of the axial-piston engine. An efficiency optimized under various operating conditions is assured in that the gas force needed for the compensation of the combustion chamber pressure is made available on demand at the components subjected to combustion chamber pressure. A gas force that always turns out to be higher may possibly lead to overcompensation of the combustion chamber pressure, whereby a compressor power that is not favorable or is poorly favorable to efficiency would be called upon for generation of the compensating pressure at the compressor stage.

In this case “idling” means the operating state in which the indicated power of the axial-piston engine corresponds in essence to the friction loss of the axial-piston engine, i.e., the effective power is zero.

The task of the invention, to improve an axial-piston engine with respect to its efficiency by separation of the oil circuit into an engine-oil circuit and a pressure-oil circuit, is supplementally accomplished in particular in that the engine-oil circuit has an engine-oil sump and an engine-oil pump and the pressure-oil circuit has a pressure-oil sump and a pressure-oil pump. This has the efficiency-increasing advantage that the engine-oil pump and the pressure-oil pump can make an independent oil volume flow available for the engine-oil circuit and the pressure-oil circuit, and thus the power demand of the engine-oil pump and of the pressure-oil pump corresponds to the requirements of the engine-oil circuit and of the pressure-oil circuit.

In order to assure the wetting of the components subjected to combustion chamber pressure, such as the control piston, for example, and other components in interaction with the control piston, it is further proposed that the pressure-oil sump have means for recording an oil level. Advantageously these means for recording an oil level are characterized in that the oil level of the pressure-oil sump determined by the means for recording an oil level is a minimum and/or a maximum oil level. This advantage contributes to the fact that not only is deficient lubrication prevented operationally reliably but also that overfilling of the pressure-oil circuit and accompanying effects such as oil foaming, oil ejection or an otherwise undesired oil escape from the pressure-oil circuit is prevented.

Furthermore it is proposed that at least one pressure space formed at a control chamber be a component of the pressure-oil circuit. The advantage of this arrangement is derived from the fact that the control chamber, which is formed on the side of the control piston facing away from the combustion chamber, can compensate for the combustion chamber pressure acting on the control piston, because of the pressure level of the pressure-oil circuit corresponding to the combustion chamber pressure level.

By “control chamber” in this case a corresponding cavity is described, which is situated on a side of the control piston or of the control pistons facing away from the combustion chamber. The side facing away from the combustion chamber is defined in addition to this by the direction of movement of the control piston. Thus the side facing away from the combustion chamber corresponds to the side of the control piston on which an applied gas pressure, in its resultant, opposes the combustion chamber pressure acting on the control piston. Further assemblies that interact with the control piston or control pistons, such as, for example, cam plates or bearing arrangements with controlling effect, can also be provided in the control chamber. In this respect, the pressure-oil circuit of the oil-circuit may also contain parts of the control piston or control pistons, wherein the oil circulating for lubrication of the control piston can flow into this control chamber after wetting of the friction pairs situated on the control piston and from here can be collected in an oil sump.

In order to implement the efficiency-optimized advantage of the compensation of a combustion chamber pressure acting on various components, it is further proposed that the pressure-oil circuit be connected via a charging line with at least one cylinder of the compressor stage. The use of such a charging line imparts the advantage that a pressure level of magnitude similar to that present in the combustion chamber can always be made available in the pressure-oil circuit operationally safely and simply on demand. Expediently and advantageously, a pressure buildup controlled or regulated via this charging line in dependence of the operating point is made available.

In order to do justice to the requirements of varying load points of the axial-piston engine, it is proposed that a charging valve be situated between at least one cylinder of the compressor stage and the pressure-oil circuit, in order to make available a pressure buildup controlled or regulated in dependence on the operating point. This charging valve can be provided in particular in the charging line already described above.

The charging valve preferably does justice to the regulation-related complexity by the fact that the charging valve is designed to be switchable, especially by the fact that the charging valve is designed to be switchable via the compressor pressure. To this end the charging valve can be operatively connected with the compressor stage and can have a corresponding control device with means for switching.

In one suitable embodiment, the charging valve can be, for example, an electrically or electronically actuated or else even a pneumatically actuated valve. Thus the charging valve can be actuated indirectly by a control instrument or by the control device or else even directly by the compressor pressure present at the valve. If the compressor pressure exceeds a specified value, for example, the charging valve can open and the compressor stage can be connected with the pressure-oil circuit, whereby charging of the pressure-oil circuit with compressed air or another medium present in the compressor stage takes place.

Corresponding to the load points present during operation of the axial-piston engine, the charging valve is advantageously characterized in that the charging valve switches at a charging pressure of 5 bar, preferably at 10 bar, most preferably at 30 bar. This has the advantage that a pressure that is necessary for compensation of a combustion chamber pressure acting on a component or that very largely corresponds to this can be made available in the pressure-oil circuit. Furthermore, escape of pressure from the pressure-oil circuit is effectively prevented by the charging valve described above, provided the compressor pressure drops below a pressure level that is present in the pressure-oil circuit. Advantageously a charging valve can be designed as a pneumatic, pressure-controlled multi-way valve, so that active control of the charging valve is possible.

Furthermore, it is also conceivable that the charging valve is a check valve, especially a pressure-controlled check valve. This permits switching of the charging valve that is structurally particularly simple, without necessitating further measures.

The use of a pressure supplied by a compressor stage of the axial-piston engine, wherein air supplied to apply this pressure or a supplied combustion agent usually has a temperature level higher than the environmental conditions during compression from environmental conditions, can have the consequence that a pressure drop after a throttling point, such as a valve represents, or cooling at a wall of the charging line, can have the consequence of condensation of a fluid. As a further configuration of the pressure-oil circuit, it is therefore proposed that an oil trap be situated between the charging valve and the pressure-oil circuit.

Since oil collected in this oil trap is already at a high pressure level, it is further proposed that a drain of the oil trap be connected with the pressure-oil sump.

Furthermore, it is proposed that a water trap be situated between the charging valve and the pressure-oil circuit. Hereby it may already be possible to collect water vapor present in the compressed air effectively before introduction of this compressed air, so that condensation of the water vapor in the pressure-oil circuit is prevented and consequently the useful life of the axial-piston engine is not limited by occurring corrosion. For the case of return flow from the pressure-oil line to the compressor stage, a loss of oil from the pressure-oil circuit can also be effectively prevented if, as proposed, an oil trap is used and a drain of the oil trap feeds the collected oil back to the pressure-oil circuit. By means of the oil trap, it is also possible in particular to prevent damage to the axial-piston engine, as could be caused in the compressor stage by self-ignition of oil-containing air.

Use, favoring efficiency, of a pressure level in the pressure-oil circuit that is higher than in the engine-oil circuit may lead to a greater oil leakage from the pressure-oil circuit into the engine-oil circuit because of the existing pressure gradient. In order to maintain the efficiency-increasing advantage of a pressure-oil circuit continuously during the entire operation of the axial-piston engine, it is therefore expedient that an equalizing valve be situated between the pressure-oil sump and the pressure-oil pump as well as between the engine-oil sump or the engine-oil pump and the pressure-oil pump. This has the advantage that exceedance of a minimum necessary oil level in the pressure-oil sump can be prevented by the fact that the pressure-oil pump draws oil from the engine-oil sump until the oil level of the pressure-oil sump reaches a maximum, but at least exceeds a minimum. This efficiency-preserving configuration of the oil circuit is further implemented by the fact that the equalizing valve is operatively connected to the means for recording an oil level.

Furthermore, it is proposed that the equalizing valve be operatively connected with a control device. Such a control device can be, for example, a control instrument of the axial-piston engine, in which performance characteristics or algorithms are resident, according to which connection of the pressure-oil circuit with the engine-oil circuit is likewise to be established in order to achieve equalization of the oil level in the pressure-oil circuit. Consequently the equalizing valve can be connected directly with the means for recording an oil level or else indirectly via a control device with the means for recording an oil level.

It is also conceivable that the control device activates the equalizing valve not only via the oil level in the pressure-oil circuit but also via the temperature or another characterizing variable, such as, for example, an emergency running signal or a maintenance signal, in order, for example, to achieve exchange of the oil present in the pressure-oil circuit.

The use of a higher pressure level in the pressure-oil circuit than in the engine-oil circuit is energetically particularly advantageous when the equalizing valve, preferably in a first operating state, connects the pressure-oil sump with the pressure-oil pump and, in a second operating state, connects the engine-oil sump or the engine-oil pump with the pressure-oil pump. This has the advantage of assuring the efficiency by use of the pressure-oil circuit to the effect that the engine-oil circuit and the pressure-oil circuit are connected only at small pressure differences between these two partial circuits, so that the power consumption of the pressure-oil pump does not lead to efficiency losses due to overcoming a large pressure difference.

For an efficiency-maintaining configuration of the equalizing valve, it is proposed cumulatively to this that the first operating state correspond to the partial load and/or to the full load of the axial-piston engine and the second operating state correspond to the idling and/or standstill state of the axial-piston engine. This configuration of the equalizing valve ensures that the equalizing valve is switched only at small pressure differences between the engine-oil circuit and the pressure-oil circuit, in order to prevent, effectively, return flow of the oil from the pressure-oil circuit into the engine-oil circuit because of a negative pressure gradient. Emptying of the pressure-oil circuit could impair the efficiency of the axial-piston engine significantly, possibly due to deficient lubrication.

Alternatively or cumulatively, it is therefore further proposed that a return-flow valve designed as a check valve be situated between the engine-oil sump and the equalizing valve or between the engine-oil pump and the equalizing valve. By means of this return-flow valve, inadvertent emptying of the pressure-oil circuit can be further prevented advantageously during a malfunction of the equalizing valve.

In particular, it is accordingly proposed that the return-flow valve have a flow direction from the engine-oil circuit to the pressure-oil circuit.

The safeguarding function of the check valve is advantageously implemented in this arrangement by the fact that hereby further filling of the pressure-oil circuit at a positive pressure gradient is possible, whereas emptying at a negative pressure gradient is suppressed.

For the implementation of an efficiency-improved axial-piston engine, a method for operation of an axial-piston engine with a compressor stage comprising at least one cylinder, with an expander stage comprising at least one cylinder and with at least one combustion chamber between the compressor stage and the expander stage is proposed, wherein a stream of combustion agent, under combustion chamber pressure, from the combustion chamber to the cylinder of the expander stage, is controlled via at least one control piston and the axial-piston engine has at least one oil circuit for lubrication, and wherein the method is characterized in that the oil circuit is split into an engine-oil circuit and into a pressure-oil circuit and components of the axial-piston engine subjected to combustion chamber pressure are lubricated by the pressure-oil circuit.

In addition to this, it is proposed that the combustion chamber pressure acting on the control piston be compensated by a pressure level present in a control chamber and corresponding to the combustion chamber pressure.

This proposed method for an axial-piston engine again contributes to an efficiency improvement of the axial-piston engine, in that, on the one hand, the two partial circuits of the oil circuit, considered independently, each work at a minimum necessary pressure level and thus the power consumption of the oil pumps present in these partial circuits is adapted to the demand, minimum and therefore optimized with respect to efficiency. On the other hand, by the compensation of a combustion chamber pressure on the components subjected to combustion chamber pressure, especially on the control piston subjected to combustion chamber pressure, piston work on the control piston, not conducive to the efficiency of the work cycle, is prevented or minimized, so that the thermodynamic efficiency of the axial-piston engine is maximized.

Advantageously, the pressure level in the control chamber corresponding to the combustion chamber pressure can be supplied by the compressor stage. This imparts the advantage that an additional aggregate or an additional assembly is not necessary for generation of a corresponding pressure level, and furthermore this has the advantage that the pressure or the pressure level supplied by the compressor stage also lies on an order of magnitude that corresponds to the combustion chamber pressure to be compensated.

Preferably, in the case of a drop below a minimum oil level in a pressure-oil sump, the pressure-oil circuit is filled with oil from the engine-oil circuit. This has the advantage that oil for lubrication of the components subject to combustion chamber pressure is always adequately available, by the fact that oil emerging from the pressure-oil circuit due to the elevated pressure is replaced by oil from the engine-oil circuit. To this end the pressure-oil circuit can be connected with the engine-oil circuit, especially during idling and/or during standstill of the axial-piston engine, since then the pressure differences are relatively small. A large difference to be overcome between the pressure-oil circuit and the engine-oil circuit can be advantageously circumvented by this proposed method, in that the removal of oil from the engine-oil circuit takes place in particular when the pressure difference between the engine-oil circuit and the pressure-oil circuit is minimum, so that the power consumption of the two pressure-oil pumps caused by this pressure difference is minimum and consequently the overall efficiency of the axial-piston engine is maximized.

Alternatively or supplementally to the last-mentioned method, the pressure-oil circuit can be connected with the engine-oil circuit at a pressure difference smaller than 5 bar between the pressure-oil circuit and the engine-oil circuit. This procedure offers the advantage that the pressure-oil circuit can be filled with oil from the engine-oil circuit when a pressure difference between the engine-oil circuit and the pressure-oil circuit has assumed a value, independently of the speed of revolution of the axial-piston engine, at which overcoming of the pressure difference necessary for filling the pressure-oil circuit requires a minimum power consumption of the oil pump used for this. Thus the pressure-oil circuit can be filled operationally reliably with favorable efficiencies even during operation of the pressure-oil circuit.

The present task is also accomplished independently of the other features of the invention by an axial-piston engine with at least one compressor cylinder, with at least one working cylinder and with at least one pressure line, through which compressed combustion agent is conducted from the compressor cylinder via a combustion chamber to the working cylinder, wherein the stream of combustion agent from the combustion chamber to the working cylinder is controlled via at least one control piston and wherein the control piston is formed from iron or steel on the combustion chamber side.

Since the control piston comes into contact with very hot working media or combustion agent of the axial-piston engine, it is advantageous when at least areas of the control piston relating to this are configured to be heat-resistant.

Advantageously, the control piston is otherwise formed from aluminum or from an alloy thereof, so that the control piston is particularly lightweight and hereby extremely short control times can be achieved.

Alternatively to this, the entire control piston could be formed from iron or steel, since the control pistons are usually small and therefore have low mass. This is a good solution in particular when extremely short control times do not play a very important role or—precisely because of the light weight of the control pistons—can nevertheless be achieved.

According to a further aspect of the invention, an axial-piston engine with at least one compressor cylinder, with at least one working cylinder and with at least one pressure line, through which compressed combustion agent is conducted from the compressor cylinder via a combustion chamber to the working cylinder, is proposed for accomplishment of the task presented in the beginning, wherein the stream of combustion agent from the combustion chamber to the working cylinder is controlled via at least one control piston, which is driven by a control drive, and wherein the axial-piston engine is characterized in that the control piston has a cavity filled with metal that is liquid at operating temperature of the axial-piston engine or a cavity filled with metal alloy that is liquid at operating temperature of the axial-piston engine. The use of a metal alloy or of a metal that is liquid at operating temperature can contribute to intensive cooling of the control piston, whereby the control piston can be advantageously used with sufficient useful life and strength even at higher temperatures.

Cumulatively to this, it is proposed that the metal or the metal alloy contains at least sodium. With its very low melting temperature and its good manipulability in the combustion engine, sodium has the advantage that it can be used in hot components. It is understood that any metal from the alkali group of the Periodic System can also be used, provided the melting temperature of the metal lies below the operating temperature of the axial-piston engine. Furthermore, it is understood that the materials mercury, gallium, indium, tin, lead or alloys of these materials as well as other liquid metals or metals that are liquid at operating temperature of the axial-piston engine can likewise be used for this purpose.

The task explained initially is also accomplished—especially in distinction relative to WO 2009/062473 A2—by an axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section released by movement of the control piston, with a main flow direction, and the control piston has a guide face parallel to the main flow direction and/or an impact face perpendicular to the main flow direction, and wherein the control piston as well as the channel has a flow cross section released by movement of the control piston, and the movement of the control piston takes place along a longitudinal axis of the control piston and the control piston has a guide face and/or an impact face at an acute angle to the longitudinal axis of the control piston.

Usually a charge exchange between two components of a combustion engine encumbered with volume is connected through a throttling point, with flow losses. Such a throttling point, which in the present situation is formed by the channel and the control piston, causes a loss of efficiency due to these flow losses. The fluidically favorable configuration of this channel and/or of the control piston therefore brings about an increase in efficiency.

Accordingly, a guide face of the control piston aligned parallel to the main flow direction has the advantage of preventing flow losses and maximizing the efficiency. In particular, when the flow is structured such that it specifically does not take place perpendicular to the longitudinal axis of the control piston, it is possible, by a guide face aligned at an acute angle to the longitudinal axis of the control piston, for the guide face to be at a favorable angle relative to a flow streaming over this guide face. Advantageously, the efficiency of the axial-piston engine is also increased by this measure, in that the flow losses at the guide face or at the control piston are minimized.

In the present case, “main flow direction” means the flow direction of the combustion agent through the channel, which is measurable and also graphically representable for laminar and even for turbulent flow of the combustion agent. The feature “parallel” therefore relates to this main flow direction and is to be understood in the mathematical or geometric sense, wherein a guide face of a control piston parallel to the main flow direction absolutely does not absorb any momentum due to the flow of the combustible material or absolutely does not change the momentum of the flow.

Provided the control piston has reached a position in which the control piston closes the released flow cross section, this impact face formed perpendicular to the main flow direction is advantageously positioned with a minimum surface relative to the combustion chamber, so that combustion agent present in this combustion chamber also brings about a minimum heat flow into the control piston. Thus, by this impact face with minimum size relative to the main flow direction, the smallest possible heat losses at the wall are also achieved, whereby the thermodynamic efficiency of the axial-piston engine is maximized in turn.

Similarly to the guide face already described above, the impact face can in turn be situated by means of the acute angle and placed in such a way in the flow of combustion agent that the impact face, provided the flow does not take place perpendicular to the control piston or to the longitudinal axis of the control piston, has a minimum surface relative to the flow. An impact face designed to be minimum in turn imparts the advantage that heat losses at the wall are reduced on the one hand and that unfavorable deflections of the flow, with formation of vortices, are minimized and the thermodynamic efficiency of the axial-piston engine is correspondingly maximized.

The guide face and/or the impact face can be a planar face, a spherical face, a cylindrical face or a conical face. A planar configuration of the guide face and/or of the impact face imparts the advantage that, on the one hand, the control piston can be produced particularly simply and cost effectively and that, on the other hand, a sealing face cooperating with the guide face can likewise be designed with simple construction and a maximum sealing effect takes place at this guide face. A spherical configuration of the guide face and/or of the impact face further imparts the advantage that this guide face is geometrically adapted particularly well to the channel following it, provided the channel also has a circular or else even elliptical cross section. Thus no undesired breakaway flows or turbulences develop at the transition from the control piston or from the guide face of the control piston to the channel. Likewise, a cylindrical guide face and/or impact face can implement the advantage that a flow with prevention of flow breakaways or turbulences can take place at a transition between the control piston and the channel or else even at a transition between the control piston and the combustion chamber. Alternatively, a conical face on the guide face and/or on the impact face can also be advantageous, provided the channel following the control piston has a cross section that is variable over the length of the channel. Should the channel be formed as a diffuser or as a nozzle, the flow can again take place without breakaway or turbulences, because of a conically shaped guide face on the control piston. It is understood that every measure explained above can be employed in itself with appropriate efficiency-maximizing effect, even independently of the other measures.

The axial-piston engine can have a guide-face sealing face between the combustion chamber and the expander stage, wherein the guide-face sealing face is formed parallel to the guide face and cooperates with the guide face at a top dead point of the control piston. Since the control piston also has a sealing effect at its top dead point, the guide-face sealing face is advantageously formed such that it cooperates over a large area with the guide face at the top dead point of the control piston and thus a sealing effect takes place. The maximum sealing effect of the guide-face sealing face is then obtained when every point of the guide-face sealing face has the same distance to the guide face, preferably zero distance to the guide face. A guide-face sealing face formed complementarily to the guide face satisfies these requirements regardless of which geometry the guide face has.

Cumulatively hereto, it is proposed that the guide-face sealing face merge on the channel side into a surface perpendicular to the longitudinal axis of the control piston. In a very simple design, the transition of the guide-face sealing face into a surface standing perpendicular to the longitudinal axis of the control piston can also consist of a sharp bend, whereby the flow streaming over the guide-face sealing face can break away at this sharp bend or at this overhang, so that the flow of combustion agent can pass over with the least possible flow losses into the channel following the control piston. It is understood that a guide face of the control piston does not necessarily have to be formed parallel to the guide-face sealing face, provided the guide-face sealing face has a breakaway edge. In this case, it is also conceivable to form the guide face even without a sharp bend or overhang.

Alternatively or cumulatively to the above features, it is proposed that the axial-piston engine have a stem-sealing face between the combustion chamber and the expander stage, wherein the stem-sealing face is formed parallel to the longitudinal axis of the control piston and cooperates with a surface of a stem of the control piston. Provided the control piston reaches its top dead point, not only does the control piston have the task of sealing relative to the combustion chamber but sealing also takes place advantageously relative to the expander stage, as takes place by the interaction of the stem of the control piston and the corresponding stem-sealing face. Hereby losses due to leakage via the control piston are once again reduced, whereby the overall efficiency of the axial-piston engine can in turn be maximized.

Furthermore, it is proposed that the guide face, the impact face, the guide-face sealing face, the stem-sealing face and/or the surface of the stem of the control piston have a reflective surface. Since each of these surfaces can be in contact with combustion agent, a flow of heat in the wall and therefore an efficiency loss can also take place via each of these faces. A reflective surface therefore prevents unnecessary losses due to heat radiation and therefore imparts the advantage of increasing the thermodynamic efficiency of the axial-piston engine correspondingly.

In order to accomplish the task of the invention further, an axial-piston engine with at least one compression cylinder, with at least one working cylinder and with at least one pressure line, through which compressed combustion agent is conducted from the compressor cylinder to the working cylinder is proposed alternatively or cumulatively, wherein the stream of combustion agent from the combustion chamber to the working cylinder is controlled via at least one control piston and wherein the axial-piston engine is characterized in that at least one surface of the control piston on the combustion chamber side is reflective. By such reflectiveness it is advantageously possible to reduce the thermal load of the respective assembly, especially by reflection of the heat-loading radiation.

Alternatively or cumulatively to this, the task of the invention can be accomplished accordingly by an axial-piston engine with at least one compression cylinder, with at least one working cylinder and with at least one pressure line, through which compressed combustion agent is conducted from the compressor cylinder to the working cylinder, wherein the stream of combustion agent from the combustion chamber to the working cylinder is controlled, via at least one control piston and wherein the axial-piston engine is characterized in that the combustion chamber has a combustion chamber floor of reflective metal.

The reflectiveness of a metal surface imparts the further advantage that the flow of heat in the wall developing due to the large temperature difference between the burned combustion agent and the metal surface can be reduced, at least for the flow of heat in the wall caused by heat radiation. A large proportion of efficiency losses in a combustion engine occurs due to this cited flow of heat in the wall, which is why an efficient and simple possibility of increasing the thermodynamic efficiency of the axial-piston engine by the proposed accomplishments of the invention is achieved by reducing the flow of heat in the wall.

It is understood that, on the one hand, even nonmetallic surfaces can impart an advantage in thermodynamic efficiency by reflectiveness and that, on the other hand, this advantage in thermodynamic efficiency can be achieved cumulatively or alternatively by the fact that each component of the axial-piston engine coming into contact with combustion agent is reflective, provided the temperature of the combustion agent is higher than the wall temperature.

Furthermore, it is understood that any other surface coating capable of increasing the spectral reflectivity of the component surfaces can be used. Obviously any surface coating is further conceivable that alternatively or cumulatively to this decreases the heat transmission coefficient of a component surface, in order to decrease the proportion of thermodynamic losses due to convection.

The object of the invention is also achieved independently of the other features of the invention by an axial-piston engine with at least one working cylinder, which is fed from a continuously working combustion chamber, wherein the combustion chamber advantageously has two combustion air inputs.

By means of a plurality of combustion air inputs, the combustion air ratio lambda (λ), i.e., the ratio of oxygen to fuel, can be adjusted particularly unproblematically. In the known manner, the entire fuel can be burned thoroughly at a value of λ=1, since exactly as much oxygen is available as is necessary for burning the entire fuel. Or else a leaner combustion mixture with a value of λ>1 is adjusted with an oxygen surplus. However, even a richer combustion mixture with λ<1 and an oxygen deficit can be adjusted particularly uniformly and rapidly when two combustion air inputs are provided. In this respect a combustion air supply via the two combustion air inputs at two different levels is advantageous.

In this case it is immaterial how the present combustion chamber of the axial-piston engine is configured. For example, the combustion chamber can be equipped with a precombustion chamber and a main combustion chamber and thus be capable of advantageous two-stage combustion.

Regulation of the two combustion air inputs can take place advantageously in dependence on speed of revolution. Alternatively, however, regulation can also be undertaken in dependence on power, so that in both cases substantially better regulation of the combustion air supply can be achieved. For example, the second or a further combustion air input will be added when this is advantageous for an operating state of the axial-piston engine.

If, in addition, the two combustion air inputs are designed for combustion air at different temperatures, easy tempering of the flame in the combustion chamber can be enabled, whereby the combustion can be controlled more simply.

At this place it must be pointed out that these same combustion air inputs to the combustion chamber do not always have to be used. Instead, even combustion air inputs that lead, for example, into an upstream mixing pipe for mixing of combustion agent can be advantageously used.

If the axial-piston engine has at least one heat exchanger, it is advantageous when a first combustion air input is fed by combustion air ahead of a heat exchanger and a second combustion air input is fed by combustion air behind this or another heat exchanger. Hereby it is possible, in structurally particularly simple manner, to supply combustion air at different temperatures. Especially in this case, regulation of the combustion air accesses can also take place on the basis of the efficiency.

If necessary, a separate combustion air heating system can also be provided, especially for starting processes, so that fuel that comes into contact with the combustion air is not cooled unnecessarily.

The task of the invention is also accomplished by an axial-piston engine with at least one working cylinder, which is fed by a continuously working combustion chamber and which has an exhaust gas outlet, wherein the axial-piston engine is characterized by a combustion chamber temperature sensor for determination of the temperature in the combustion chamber.

A temperature sensor of this sort delivers, in a simple manner, a meaningful value regarding the quality of the combustion or regarding the running stability of the axial-piston engine.

Any sensor, for example a resistance temperature sensor, a thermocouple, an infrared sensor or the like, can be used as a temperature sensor.

Preferably the combustion chamber temperature sensor is designed or situated in such a way that it measures a flame temperature in the combustion chamber. This makes it possible to determine particularly meaningful values about the combustion inside the combustion chamber.

In this case the combustion chamber temperature sensors can be situated at an almost arbitrary place inside the combustion chamber. For example, combustion chamber temperature sensors can be provided in the region of a precombustion chamber and/or of a main combustion chamber.

The axial-piston engine can include in particular a combustion chamber regulating system, which includes the combustion chamber temperature sensor as input sensor and regulates the combustion chamber so that the combustion chamber temperature is between 1,000° C. and 1,500° C. In this way it is possible, by means of a relatively simple and therefore operationally reliable and very fast regulating circuit, to guarantee that the axial-piston engine produces extremely little pollutants. In particular, the danger that soot will be formed can be reduced to a minimum. The combustion chamber temperature can be regulated particularly rapidly and therefore advantageously when two or even more combustion air supply lines are used, especially with combustion air at different temperatures.

Furthermore, the axial-piston engine, cumulatively or alternatively to this, can include an exhaust gas temperature sensor for determination of the exhaust gas temperature. The operating state of a continuously working combustion chamber can likewise be checked and regulated in technically simple manner by such an exhaust gas temperature sensor.

Such a regulating system ensures adequate and complete combustion of fuel, in particular in a simple way, so that the axial-piston engine exhibits optimum efficiency with minimum emission of pollutants.

Advantageously, the combustion chamber regulating system includes the exhaust gas temperature sensor as an input sensor. By preference, the combustion chamber is regulated so that the exhaust gas temperature in an operating state, preferably when idling, is between 850° C. and 1,200° C. The latter can be done for example through the appropriate application of water and/or appropriate preheating of the combustion agent, in particular of air, for example by controlling the water temperature or volume of water or else the proportion of air preheated or not preheated in a heat exchanger, in accordance with the aforementioned requirement. Such a regulating system based on water cooling is not known from the initially relevant state of the art.

Such an operating state is advantageously idling of the axial-piston engine, whereby a further reduction of pollutants can be achieved.

In order to be able to regulate especially even a precombustion chamber temperature advantageously in the present case, the combustion chamber temperature sensor can, cumulatively or alternatively, also include a prechamber temperature sensor.

Furthermore, the task of the invention is accomplished by an axial-piston engine with at least one working cylinder, which is fed from a continuously working combustion chamber, wherein the axial-piston engine has a combustion chamber regulation system that includes application of water into the combustion chamber.

An expanded regulation capability can be achieved when the application of water is provided independently of application of water in or ahead of a combustion agent compressor. In this case water is ideally applied directly into the combustion chamber for cooling.

If the application of water is provided independently of application of water in or ahead of a combustion agent compressor, further diverse and therefore advantageous regulation and cooling variations can be achieved thereby.

The application of water can take place in the precombustion chamber.

Cumulatively or alternatively to this, the application of water can also be carried out advantageously into the main combustion chamber, which is particularly advantageous. In particular, the application of water can be carried out in such a way that the water was used beforehand as a coolant, especially for a combustion space. Also, the water or the water vapor is applied into a combustion chamber in such a way that it flows along a wall of the combustion chamber, so that in this way also the combustion chamber wall is preserved as well as possible.

If the application of water is used for regulation of exhaust gas temperature, especially the heat transmission to the combustion air in a heat exchanger can be advantageously regulated.

The proportion of water—depending on the concrete implementation—can be used supplementally for regulation of the temperature in the combustion chamber, and/or also for reduction of pollution by means of chemical or catalytic reactions of the water.

According to another aspect of the invention, an axial-piston engine with a compressor stage comprising at least one cylinder, with an expander stage comprising at least one cylinder, and with at least one heat exchanger is proposed, wherein the heat-absorbing part of the heat exchanger is situated between the compressor stage and the combustion chamber and the heat-emitting part of the heat exchanger is situated between the expander stage and an environment, and wherein the axial-piston engine is characterized by the fact that the heat-absorbing and/or the heat-emitting part of the heat exchanger has, downstream and/or upstream, means for applying at least one fluid.

The application of a fluid into the stream of combustion agent can contribute to an increase in the transfer capacity of the heat exchanger, for example since the specific heat capacity of the stream of combustion agent can be adjusted to the specific heat capacity of the exhaust gas stream, through the application of a suitable fluid, or else can be increased beyond the specific heat capacity of the exhaust gas stream. The transfer of heat from the exhaust gas stream to the combustion agent stream influenced thereby, for example advantageously, contributes to the ability of a higher quantity of heat to be coupled into the combustion agent stream and thus into the working cycle while the construction size of the heat exchanger remains the same, whereby the thermodynamic efficiency can be increased. Alternatively or cumulatively, a fluid can also be applied to the exhaust gas stream. The applied fluid in this case can be for example a necessary aid for a downline exhaust gas post-treatment, which can be mixed ideally with the exhaust gas stream by a turbulent flow formed in the heat exchanger, so that a downline exhaust gas post-treatment system can thus be operated with maximum efficiency.

“Downstream” designates in this case the side of the heat exchanger from which the particular fluid emerges, or that part of the exhaust gas line or of the pipework carrying the combustion agent into which the fluid enters after leaving the heat exchanger.

By analogy to this, “upstream” designates the side of the heat exchanger into which the particular fluid enters, or that part of the exhaust gas line or of the pipework carrying the combustion agent from which the fluid enters into the heat exchanger.

In this respect, it does not matter whether the application of the fluid takes place immediately in the near spatial vicinity of the heat exchanger, or whether the application of the fluid takes place at a greater spatial distance.

Water and/or combustible substance for example can be applied appropriately as fluid. This has the advantage that the combustion agent stream has on the one hand the previously described advantages of an increased specific heat capacity through the application of water and/or combustible substance, and on the other hand that the mixture can be prepared already in the heat exchanger or ahead of the combustion chamber and the combustion can take place in the combustion chamber with a combustion air ratio of the greatest possible local homogeneity. This also has in particular the advantage that the combustion behavior is marked only very slightly or not at all with efficiency-degrading, incomplete combustion.

For another configuration of an axial-piston engine, it is proposed that a water trap be situated in the heat-emitting part of the heat exchanger or downstream from the heat-emitting part of the heat exchanger. Because of the reduced temperature existing at the heat exchanger, vaporous water could condense out and damage the subsequent exhaust gas line by corrosion. Damage to the exhaust gas line can be reduced advantageously through this measure.

In addition, a method for operating an axial-piston engine with a compressor stage comprising at least one cylinder, with an expander stage comprising at least one cylinder, with at least one combustion chamber between the compressor stage and the expander stage and with at least one heat exchanger is proposed, wherein the heat-absorbing part of the heat exchanger is situated between the compressor stage and the combustion chamber and the heat-emitting part of the heat exchanger is situated between the expander stage and an environment, and wherein the method is characterized by the fact that at least one fluid is applied to the combustion agent stream flowing through the heat exchanger and/or to the exhaust gas stream flowing through the heat exchanger. It is hereby possible—as already shown above—to improve the efficiency-enhancing transfer of heat from an exhaust gas stream being conducted into an environment into a combustion agent stream, by increasing the specific heat capacity of the combustion agent stream through the application of a fluid, and thus also increasing the flow of heat to the combustion agent stream. The regenerative coupling of an energy stream into the working cycle of the axial-piston engine in this case can in turn bring about an increase in efficiency, in particular an increase in the thermodynamic efficiency, when the process is carried out appropriately.

Advantageously, the axial-piston engine is operated in such a way that water and/or combustible substance are applied. The result of this procedure is that the efficiency in turn, in particular the efficiency of the combustion process, can be increased through ideal mixing in the heat exchanger and ahead of the combustion chamber.

Combustible substance can likewise be applied to the exhaust gas flow, if this is expedient for example for an exhaust gas aftertreatment, so that the exhaust gas temperature can be further increased in the heat exchanger or after the heat exchanger. If necessary, postcombustion, which aftertreats the exhaust gas in an advantageous manner and minimizes pollutants, can also be carried out in this way. Heat released in the heat-emitting part of the heat exchanger could thus also be used indirectly for further warming of the combustion agent stream, so that the efficiency of the axial-piston engine is hardly influenced negatively thereby.

In order to further implement this advantage, it is further proposed that the fluid be applied downstream and/or upstream from the heat exchanger.

Cumulatively or alternatively to this, separated water can be applied back into the combustion agent stream and/or the exhaust gas stream. In the most favorable case, a closed water circuit is thereby realized, to which no additional water needs to be supplied from outside. Thus an additional advantage arises from the fact that a vehicle or a stationary system equipped with an axial-piston engine of this construction does not have to be refilled with water, in particular not with distilled water.

Advantageously, the application of water and/or combustible substance is stopped at a defined point in time before the axial-piston engine comes to a standstill, and the axial-piston engine is operated until it comes to a stop without an application of water and/or combustible substance. The water, possibly harmful for an exhaust gas line, which can be deposited in the exhaust gas line, in particular when the latter cools, can be avoided by this method. Advantageously, any water is also removed from the axial-piston engine itself before the axial-piston engine comes to a stop, so that damage to components of the axial-piston engine by water or water vapor, especially during the stoppage, is not promoted.

The task is also accomplished by an axial-piston engine with a combustion agent supply system and an exhaust gas removal system that are coupled with one another with heat transfer, which is characterized by at least two heat exchangers.

Although two heat exchangers initially lead to a greater expense and more complex flow conditions, the use of two heat exchangers makes possible significantly shorter paths to the heat exchanger and a more favorable energy arrangement of the latter. This surprisingly allows the efficiency of the axial-piston engine to be increased significantly.

This is true in particular for axial-piston engines with stationary cylinders in which the pistons work in each instance, in contrast to axial-piston engines in which the cylinders and therefore the pistons also rotate around the axis of rotation, since the latter arrangement needs only one exhaust gas line, alongside which the cylinders are guided.

Preferably, the heat exchangers are positioned essentially axially, wherein the term “axially” in the present context designates a direction parallel to the main axis of rotation of the axial-piston engine, or parallel to the axis of rotation of the rotational energy. This allows an especially compact and therefore energy-saving design.

Furthermore, the heat exchangers can be insulated, which is advantageous, however, even independently of the other features of the present invention.

If the axial-piston engine has at least four pistons, then it is advantageous if the exhaust gases from at least two adjacent pistons are conducted into one heat exchanger, in each instance. In this way, the paths between piston and heat exchanger for the exhaust gases can be minimized, so that losses in the form of waste heat that cannot be recovered by way of the heat exchangers can be reduced to a minimum.

The latter can even be achieved if the exhaust gases from three adjacent pistons are conducted into one common heat exchanger, in each instance.

On the other hand, it is also conceivable that the axial-piston engine comprises at least two pistons, whereby the exhaust gases from each piston are conducted into a heat exchanger of their own. In this respect, it can be advantageous—depending on the concrete implementation of the present invention—if a heat exchanger is provided for each piston. It is true that this leads to an increased construction expense; but on the other hand, the heat exchangers can each be smaller, and therefore possibly of simpler construction, whereby the axial-piston engine as a whole is built more compactly and thus is subject to smaller losses.

According to a further aspect of the invention, an axial-piston engine with a compressor stage comprising at least one cylinder, with an expander stage comprising at least one cylinder and with at least one combustion chamber between the compressor stage and the expander stage is proposed, which is characterized in that the compressor stage has a stroke volume different from the expander stage.

In particular, it is proposed cumulatively to this, that the stroke volume of the compressor stage is smaller than the stroke volume of the expander stage.

Furthermore, a method for operation of an axial-piston engine with a compressor stage comprising at least one cylinder, with an expander stage comprising at least one cylinder and with at least one combustion chamber between the compressor stage and the expander stage is proposed, which is characterized in that a combustion agent or a burned combustion agent present as exhaust gas is expanded during expansion in the expander stage with a greater pressure ratio than a pressure ratio existing during compression in the compressor stage.

The thermodynamic efficiency of the axial-piston engine can be advantageously maximized particularly advantageously by these measures in each instance, since, in contrast to the state of the art heretofore, as in WO 2009/062473, for example, the theoretical thermodynamic potential of a work cycle implemented in an axial-piston engine can be utilized to the maximum by the prolonged expansion permitted hereby. In an engine drawing from the environment and exhausting into this same environment, the thermodynamic efficiency due to this measure reaches its maximum efficiency in this respect when the expansion takes place up to the pressure of the environment.

Therefore a method for operation of an axial-piston engine is further proposed, by means of which the combustion agent is expanded in the expander stage approximately up to the pressure of an environment.

By “approximately”, an environmental pressure raised at the maximum by the amount of the mean friction pressure of the axial combustion engine is meant. Compared with expansion up to the amount of the mean friction pressure, expansion up to the exact environmental pressure does not bring about any substantial advantage in efficiency at a mean friction pressure different from 0 bar. The amount of the mean friction pressure can be interpreted as a pressure that is constant on average acting on the piston, wherein the piston is to be considered as free of forces when the cylinder internal pressure acting on the top side of the piston is equal to the environmental pressure acting on the bottom side of the piston plus the mean friction pressure. Therefore a more favorable overall efficiency of a combustion engine is already achieved upon reaching a relative expansion pressure that lies at the level of the mean friction pressure.

Advantageously, an axial-piston engine for implementation of this advantage can be further designed in such a way that an individual stroke volume of at least one cylinder of the compressor stage is smaller than the individual stroke volume of at least one cylinder of the expander stage. In particular, it is conceivable, by means of a large individual stroke volume of the cylinders of the expander stage, in the case that the numbers of cylinders of the expander stage and of the compressor stage are to remain identical, to influence the thermodynamic efficiency by exerting a favorable influence on the surface-to-volume ratio, whereby smaller losses of heat in the wall are achieved in the expander stage. In this case it is understood that this configuration is advantageous for an axial-piston engine with a compressor stage comprising at least one cylinder, with an expander stage comprising at least one cylinder, with at least one combustion chamber between the compressor stage and the expander stage, even independently of the other features of the present invention.

Alternatively or cumulatively, it is also proposed that the number of cylinders of the compressor stage be equal to or smaller than the number of cylinders of the expander stage.

In addition to the above advantages, the mechanical efficiency of the axial-piston engine and thus also the overall efficiency of the axial-piston engine can be maximized by the choice of a suitable number of cylinders, especially a decreased number of cylinders, with identical individual stroke volume of a cylinder of the expander and compressor stages, in that at least one cylinder of the compressor stage is omitted for achievement of a prolonged expansion and thus the friction loss of the omitted cylinder likewise no longer has to be applied. Some imbalances that could be caused by such an asymmetry of the arrangement of pistons or cylinders can be tolerated under certain circumstances or prevented by supplementary measures.

For accomplishment of the task set in the beginning, an axial-piston engine with a compressor stage comprising at least one cylinder, with an expander stage comprising at least one cylinder and with at least one combustion chamber between the compressor stage and the expander stage is further proposed, which is characterized in that at least one cylinder has at least one gas-exchange valve of a light metal. Light metal, especially during use of moving components, reduces the inertia of the components consisting of this light metal and, because of its low density, can reduce the friction loss of the axial-piston engine to the effect that the control drive of the gas-exchange valves is designed to correspond to the lower inertial forces. The reduction of the friction loss by use of components of light metal leads in turn to a smaller overall loss of the axial-piston engine and simultaneously to an increase of the overall efficiency.

Cumulatively to this, it is proposed that the axial-piston engine be characterized in that the light metal is aluminum or an aluminum alloy, especially dural. Aluminum, especially a strong or very strong aluminum alloy such as dural or duraluminum, offers special advantages for a configuration of a gas-exchange valve, since in this case not only the weight of a gas-exchange valve via the density of the material but also the strength of a gas-exchange valve can be increased or maintained at a high level. Obviously it is also conceivable that the material titanium or magnesium or an alloy of aluminum, titanium, magnesium and/or further components can be used instead of aluminum or an aluminum alloy. In particular, a correspondingly lightweight gas-exchange valve can follow load exchanges correspondingly faster than can be done, already on the basis of the greater inertia, by a heavy or denser gas-exchange valve

In particular, the gas-exchange valve can be an inlet valve. The advantage of a lightweight gas-exchange valve and of an associated lower mean friction pressure or a smaller friction loss of the axial-piston engine can be implemented especially during use of an inlet valve of a light material, since low temperatures, which have a sufficient distance from the melting temperature of aluminum or aluminum alloys, are present at this place of the axial-piston engine. On the other hand, it is understood that the advantages of a gas-exchange valve of a light metal can also be employed correspondingly advantageously, cumulatively to the configurations mentioned above in relation to the compressor cylinder outlet valves and the compressor cylinder inlet valves.

The task of the invention is also accomplished by an axial-piston engine with at least one compressor cylinder, with at least one working cylinder and with at least one pressure line, through which compressed combustion agent is conducted from the compressor cylinder to the working cylinder, wherein the stream of combustion agent from the combustion chamber to the working cylinder through a shot channel is controlled via at least one control piston, which, driven by a control drive, opens and closes the shot channel, and the control piston has opening and closing times that differ from one another.

Because the opening and closing times differ from one another, particularly high adaptability to different operating situations can be achieved in the present axial-piston engine. In this respect, such asymmetric control times are advantageous.

An alternative embodiment preferred in this regard can advantageously cause the control piston to be closed faster than opened in the present case. Hereby it can be achieved operationally reliably that adequate time is always available for filling the respective cylinder. In this case, however, care is to be taken that a blowback into the combustion chambers does not occur in view of the expansion work to be done, as can be guaranteed by such asymmetric control times. Furthermore, the danger can be reduced that the working cylinder in particular will be critically filled with combustion agent, which can lead to overload of the working piston.

The task of the present invention is also accomplished by an axial-piston engine with at least one working cylinder, which is fed from a continuously working combustion chamber, which comprises a precombustion chamber and a main combustion chamber and which has an exhaust gas outlet, wherein the axial-piston engine is characterized by a precombustion chamber temperature sensor for determination of a temperature in the precombustion chamber.

A temperature sensor of this sort delivers, in a simple manner, a meaningful value regarding the quality of the combustion or regarding the running stability of the axial-piston engine. Any sensor, for example a resistance temperature sensor, a thermocouple, an infrared sensor or the like, can be used as a temperature sensor

Preferably, the precombustion chamber temperature sensor is designed or situated so that it determines the temperature of a flame in the precombustion chamber. This makes quite especially appropriately meaningful values possible.

The axial-piston engine can include in particular a combustion chamber regulating system, which includes the precombustion chamber temperature sensor as input sensor and regulates the combustion chamber so that the prechamber temperature is between 1,000° C. and 1,500° C. In this way it is possible, by means of a relatively simple and therefore operationally reliable and very fast regulating circuit, to guarantee that the axial-piston engine produces extremely little pollutants. In particular, the danger that soot will be formed can be reduced to a minimum.

Furthermore, cumulatively or alternatively to this, the axial-piston engine can include an exhaust gas temperature sensor for determination of the exhaust gas temperature.

By means of such an exhaust gas temperature sensor, the operating state of a continuously working combustion chamber can likewise be checked and regulated in a technically simple way. Such a regulating system ensures adequate and complete combustion of fuel, in particular in a simple way, so that the axial-piston engine exhibits optimal efficiency with minimum emission of pollutants.

By preference, the combustion chamber is regulated so that the exhaust gas temperature in an operating state, preferably when idling, is between 850° C. and 1,200° C. The latter can be done for example through the appropriate application of water and/or appropriate preheating of the combustion agent, in particular of air, for example by controlling the water temperature or volume of water or else the proportion of air preheated or not preheated in a heat exchanger, in accordance with the aforementioned requirement.

The task of the present invention is accomplished cumulatively or alternatively to the aforementioned features by an axial-piston engine with at least one compressor cylinder, with at least one working cylinder and with at least one pressure line, through which compressed combustion agent is conducted from the compressor cylinder to the working cylinder, wherein the axial-piston engine is characterized by the fact that water or water vapor is applied to the compressor cylinder during an intake stroke of a compressor piston situated in the compressor cylinder.

On the one hand, this ensures excellent distribution of the water in the combustion agent. On the other hand, the compression enthalpy modified by the water can be introduced non-critically into the combustion agent, without the energy balance of the entire axial-piston engine being influenced too disadvantageously by the application of water. In particular, the compression process of an isothermal compression can be approximated thereby, whereby the energy balance can be optimized during the compression. The proportion of water—depending on the concrete implementation and also in combination with the application of water explained above in connection with a heat exchanger—can be used supplementally to regulate the temperature in the combustion chamber, and/or also to reduce pollution by means of chemical or catalytic reactions of the water.

The application of water can be done for example, depending on the concrete implementation of the present invention, by a metering pump. A metering pump can be dispensed with by means of a check valve, since then the compressor piston can also draw in water during its intake stroke through the check valve, which then closes during compression. The latter implementation is especially advantageous if a safety valve, for example a solenoid valve, is also provided in the water supply line in order to prevent leakage when the engine is stopped.

It is understood that water can possibly also be applied to the axial-piston engine even at a different place.

According to a further aspect of the invention, an axial-piston engine with a compressor stage comprising at least one cylinder, with an expander stage comprising at least one cylinder, with at least one combustion chamber between the compressor stage and the expander stage is proposed, wherein the axial-piston engine includes a gas exchange valve that oscillates and releases a flow cross section, and the gas exchange valve closes this flow cross section by means of a spring force of the valve spring acting on the gas-exchange exchange valve, and wherein the axial-piston engine is characterized in that the gas exchange valve has an impact spring. Gas exchange valves that are self-actuated, i.e., not cam-actuated, which open at an applied pressure difference, can be accelerated so strongly, when the pressure difference present causes a very large opening force, that either the valve spring of the gas exchange valve becomes solidly compressed or strikes the valve spring plate or else even a comparable bracing ring on another component. Such impermissible and undesired contact between two components can very quickly lead to destruction of these components. In order to prevent slamming of the valve spring plate effectively, a further spring designed as an impact spring is therefore advantageously provided, which dissipates excess kinetic energy of the gas exchange valve and brakes the gas exchange valve to a standstill.

In particular, the impact spring can have a shorter spring length than a spring length of the valve spring. Provided the two springs, the valve spring and the impact spring, have a common bearing face, the impact spring is advantageously designed such that the spring length of the installed valve spring is always shorter than the spring length of the impact spring, so that the valve spring, upon opening of the gas exchange valve, initially applies exclusively the forces necessary to close the gas exchange valve and, after the maximum provided valve stroke has been reached, the impact spring comes into contact with the gas exchange valve, in order immediately to prevent further opening of the gas exchange valve.

Cumulatively to this, the spring length of the impact spring can correspond to the spring length of the valve spring decreased by a valve stroke of the gas exchange valve. Expediently and advantageously in this case, the circumstance is used that the difference of the spring lengths of the two springs corresponds precisely to the amount of the valve stroke.

In this case the term “valve stroke” denotes the stroke of the gas exchange valve from which the flow cross section released by the gas exchange valve reaches approximately a maximum. A plate valve commonly used in engine construction usually has a linearly increasing geometric flow cross section at small degree of opening, which then merges into a line with constant value upon further opening of the valve. The maximum geometric opening cross section is usually reached when the valve stroke reaches 25% of the internal valve seat diameter. The internal valve seat diameter is the smallest diameter present at the valve seat.

The term “spring length” in this case denotes the maximum possible length of the impact spring or of the valve spring in the installed state. Thus the spring length of the impact spring corresponds exactly to the spring length in the untensioned state and the spring length of the valve spring exactly to the length that the valve spring has in the installed state with the gas exchange valve closed.

Alternatively or cumulatively to this, it is further proposed that the spring length of the impact spring correspond to a height of a valve guide increased by a spring travel of the impact spring. This has the advantage that a valve guide, but also any other fixed component that can come into contact with a moving component of the valve control system, absolutely does not come into contact with a moving component of the valve control system, since the impact spring, even upon reaching the provided spring travel, is absolutely not compressed so much that contact occurs.

The term “spring travel” in this case denotes the spring length minus the length of the spring that exists at maximum load. The maximum load in turn is defined via the computed design of the valve drive, including a factor of safety. Thus the spring travel is exactly the length by which the spring is compressed when the maximum load occurring in operation of the axial-piston engine or the maximum valve stroke provided in operation of the axial-piston engine occurs during abnormal load. The maximum valve stroke in this case denotes the valve stroke defined above plus a stroke of the gas exchange valve at which contact between a moving component and a fixed component just occurs.

Any other component that can come into contact with moving parts of the valve drive can take the place of a valve guide.

Furthermore, upon reaching the spring travel of the impact spring, the impact spring may have a potential energy that corresponds to the maximum operationally caused kinetic energy of the gas exchange valve upon release of the flow cross section. Precisely upon satisfaction of this physical or kinetic condition, braking of the gas exchange valve is advantageously achieved precisely when contact between two components is just not made. As explained above, the maximum operationally caused kinetic energy is the kinetic energy of the gas exchange valve that can occur for the computed design of the valve drive, including a factor of safety. The maximum operationally caused kinetic energy is caused by the maximum pressures or pressure differences present at the gas exchange valve, whereby the gas exchange valve is accelerated on the basis of its mass and, after decay of this acceleration, acquires a maximum speed of motion. Excess kinetic energy stored in the gas exchange valve is absorbed via the impact spring, so that the impact spring becomes compressed and has potential energy. Upon reaching the spring travel of the impact spring or upon maximum provided compression of the impact spring, dissipation of the kinetic energy of the gas exchange valve or of the valve group to the amount of zero is advantageous, so that contact between two components just does not occur. The term “maximum operationally caused kinetic energy” therefore likewise encompasses the kinetic energies of all components moved with the gas exchange valve, such as, for example, the valve keys, valve spring plates or valve springs.

The task mentioned at the beginning is also accomplished by a method for production of a heat exchanger of an axial-piston engine which has a compressor stage comprising at least one cylinder, an expander stage comprising at least one cylinder and at least one combustion chamber between the compressor stage and the expander stage, wherein the heat-absorbing part of the heat exchanger is situated between the compressor stage and the combustion chamber and the heat-emitting part of the heat exchanger is situated between the expander stage and an environment, wherein the heat exchanger includes at least one pipe wall dividing the heat-emitting part from the heat-absorbing part of the heat exchanger to separate two streams of material, and wherein the production process is characterized by the fact that the pipe is situated in at least one matrix consisting of a material corresponding to the pipe, and connected materially and/or frictionally to this matrix.

The use of a heat exchanger in an axial-piston engine described above can lead to disadvantages through the occurrence of especially high temperature differences between the input and between the output of the heat exchanger on the one hand and between the heat-absorbing and heat-emitting part of the heat exchanger on the other hand, due to damage to the material that limits the service life. In order to counter thermal stresses that result from this and losses of combustion agent or exhaust gas that occur due to damage, with appropriate design, according to the proposal described above, a heat exchanger can be produced advantageously almost exclusively of only one material at its points that are subject to a critical stress. Even if the latter is not the case, material stresses are advantageously reduced through the solution described above.

It is understood that a solder or other means used for fixing or mounting the heat exchanger can consist of a different material, especially when regions with a high thermal stress or with a high seal tightness requirement are not in question.

The use of two or more materials with the same thermal expansion coefficients is also conceivable, whereby the occurrence of thermal stresses in the material can be countered in similar manner.

To construct a material and/or frictional connection between the pipe and the matrix, a method for production of a heat exchanger is further proposed, which is characterized in that the material Connection between the pipe and the matrix is made by welding or soldering. The seal tightness of a heat exchanger is ensured in a simple manner and especially advantageously by a method of this sort. In this case it is again also possible to use a material corresponding to the pipe or to the matrix as the welding or soldering material.

Alternatively or cumulatively to this, the frictional bond between the pipe and the matrix can also be accomplished by shrinking. This in turn has the advantage that thermal stresses between the pipe and the matrix can be prevented, since the use of a material that is different from the material of the pipe or of the matrix, for example, in a materially bonded connection, is avoided. In order to further implement this advantage, the fluid can be applied downstream and/or upstream from the heat exchanger.

Additional advantages, objectives and properties of the present invention will be explained on the basis of the following description of the enclosed drawing, in which examples of various axial-piston engines and their assemblies are depicted

The figures show the following:

FIG. 1 a schematic sectional view of a first axial-piston engine;

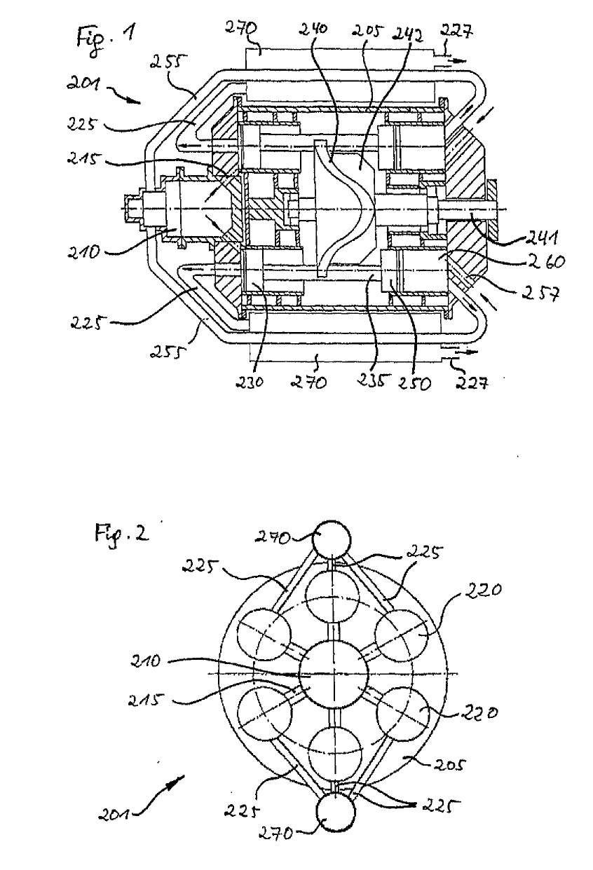

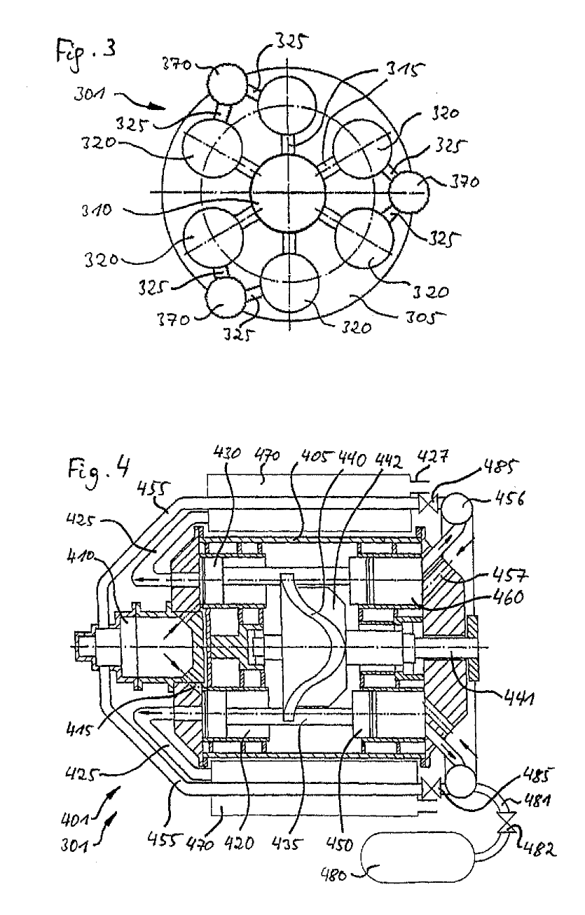

FIG. 2 a schematic top view of the axial-piston engine according to FIG. 1;

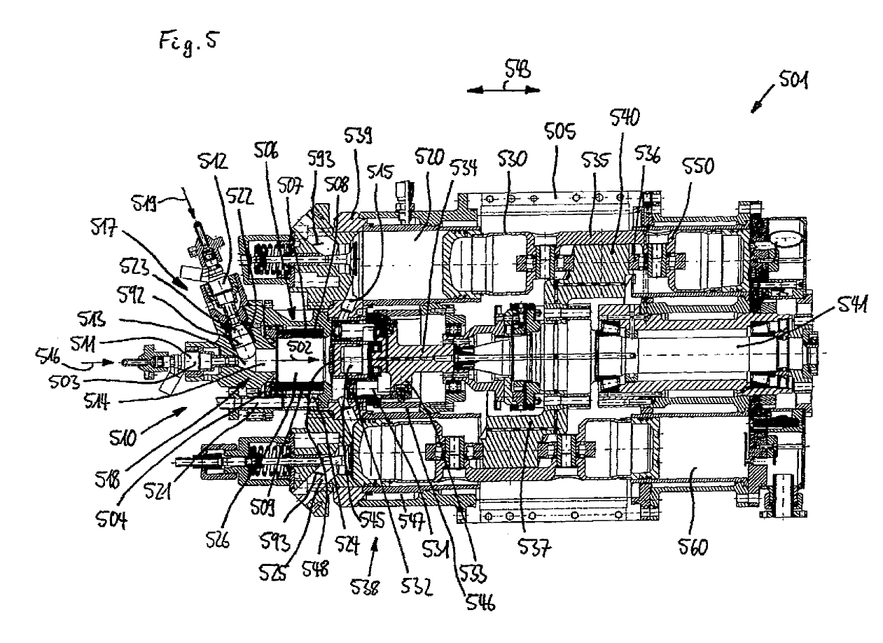

FIG. 3 a schematic top view of a second axial-piston engine, in a depiction similar to that in FIG. 2;

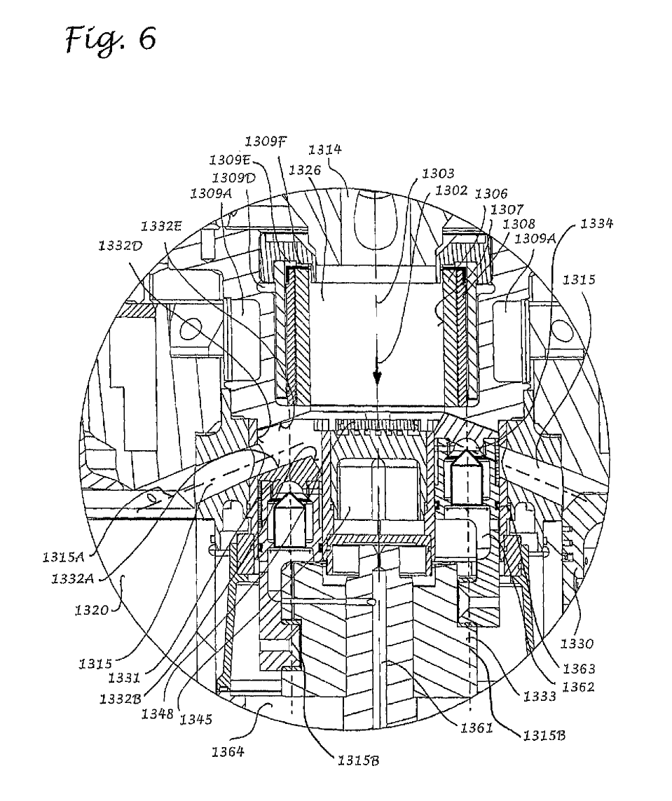

FIG. 4 a schematic sectional view of a third axial-piston engine, in a depiction similar to that in FIG. 1;

FIG. 5 a schematic sectional view of a further axial-piston engine with a precombustion temperature sensor and two exhaust gas temperature sensors;

FIG. 6 a schematic sectional view of a further axial-piston engine with a control chamber formed as a pressure space, a cutaway view of the oil circuit and an alternative configuration of the control pistons;

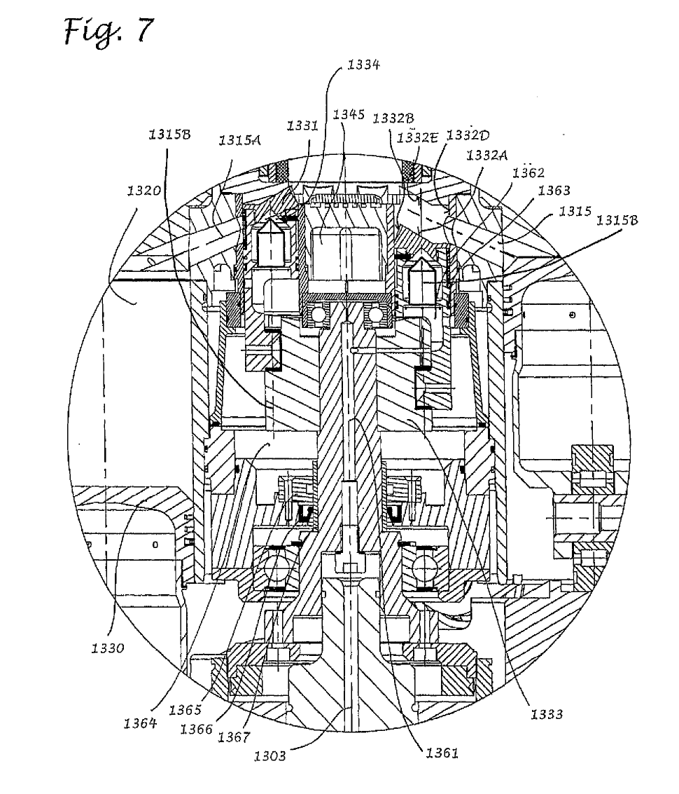

FIG. 7 a schematic sectional view of a further axial-piston engine with a control chamber formed as a pressure space, a cutaway view of the oil circuit and an alternative configuration of the control pistons;

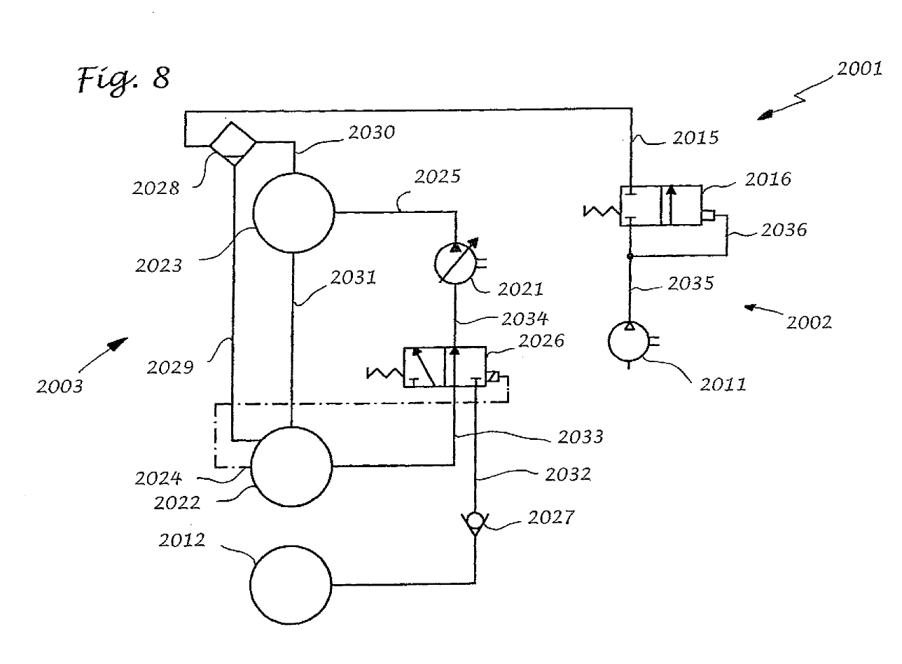

FIG. 8 a schematic view of an oil circuit for an axial-piston engine with a pressure-oil circuit;

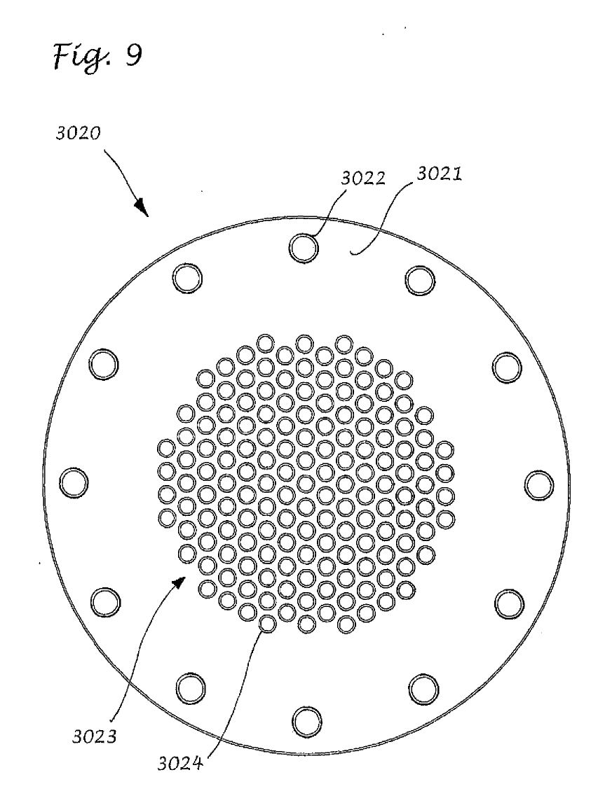

FIG. 9 a schematic view of a flange for a heat exchanger, with a matrix situated in it for accommodation of pipes of a heat exchanger;

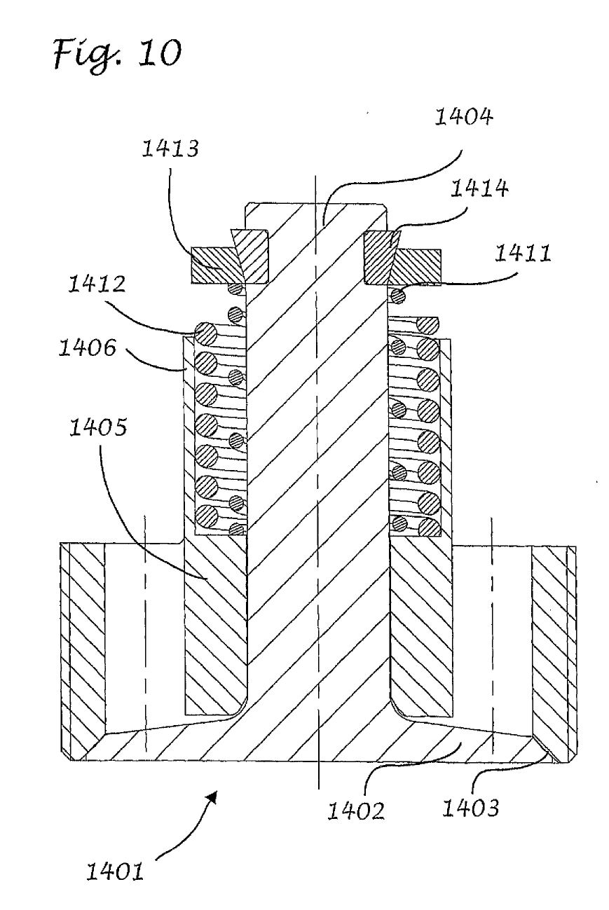

FIG. 10 a schematic sectional view of a gas exchange valve with a valve spring and an impact spring; and

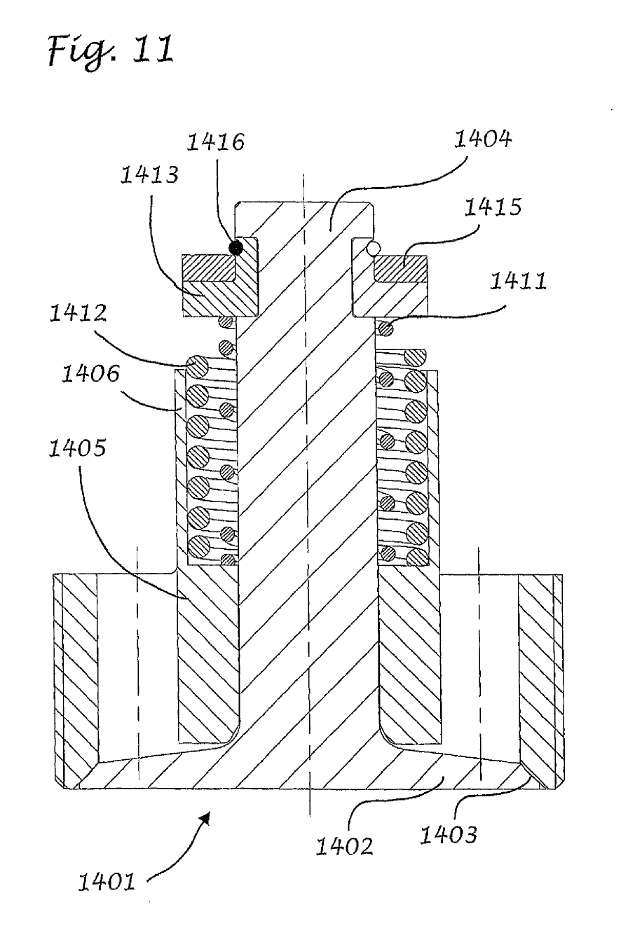

FIG. 11 a further schematic sectional view of a gas exchange valve with a valve spring and an impact spring.

The axial-piston engine 201 depicted in FIGS. 1 and 2 has a continuously working combustion chamber 210, from which working medium is supplied successively via shot channels 215 (numbered as an example) to working cylinders 220 (numbered as an example).

The combustion chamber 210 has two combustion air inputs (not depicted here) different from one another in order that the application of combustion air into the combustion chamber 210 can be varied and adjusted particularly well. In particular, hereby the lambda value can be adjusted extremely well to the axial-piston engine 201, whereby the combustion inside the combustion chamber 210 can be equalized very exactly and rapidly to real-time power requirements of the axial-piston engine 201. Advantageously, combustion air at different temperatures can also be introduced into the combustion chamber 210 via the two combustion air inputs, whereby the combustion can be controlled more easily.

A stream of working medium or a stream of combustion agent inside one of the shot channels 215 from the combustion chamber 210 to the respective working cylinder 220 is controlled by means of a control piston (not shown explicitly here), which is driven by a control drive (not shown explicitly here).

Advantageously, the control piston, besides the force applied by the control drive, is additionally subjected further to a compensating force directed counter to a combustion chamber pressure, so that the control drive can be designed with particularly simple construction. On the basis of the existing compressor cylinder pressure, the compensating force can be generated pneumatically with particularly little construction complexity.

In particular, sealing at the respective control piston can be undertaken extremely simply when the control piston is situated in a pressure space, in which similar pressure conditions exist as in the combustion chamber 210. In this case, ideally adequate seal tightness is already achieved by means of pure oil scraping.

To this end, the control piston is also always wetted with oil, whereby it is simultaneously lubricated and cooled, wherein the control piston is preferably spray-cooled in this case. For scraping of the oil, the control piston is equipped with an oil scraper, not shown in more detail here, by means of which the oil can be returned in a separate oil circuit.

In order to be able to reduce the moving masses even with respect to the present control piston, the control piston is made from aluminum, at least with respect to its piston stem. In the region of the piston bottom, however, the control piston consists of an iron alloy on the combustion chamber side, in order that it can better withstand even very high combustion agent temperatures.

Alternatively, the control piston can also be made of a steel alloy, so that it is even more improbable that strength and/or stiffness problems as well as thermal difficulties can occur than with respect to an aluminum alloy.

Situated in each of the working cylinders 220 are working pistons 230 (numbered as an example), which are connected on the one hand by way of a straight connecting rod 235 to an output, which is realized in this exemplary embodiment as a spacer 242 carrying a curved track 240, situated on an output shaft 241, and are connected on the other hand to a compressor piston 250, each of which runs in the compressor cylinder 260 in a manner explained in greater detail below.

After the working medium has performed its work in the working cylinder 220 and has placed a load on the working piston 230 accordingly, the working medium is expelled from working cylinder 220 through exhaust gas channels 225. Provided on the exhaust gas channels 225 are temperature sensors, not shown, which measure the temperature of the exhaust gas.

The exhaust gas channels 225 discharge into heat exchangers 270, in each instance, and subsequently leave the axial-piston engine 201 at appropriate outlets 227 in a known manner. The outlets 227 for their part can be connected again in particular to a ring channel, not shown, so that in the end the exhaust gas leaves the engine 201 at only one or two places. Depending on the concrete configuration in particular of the heat exchanger 270, a sound damper can possibly also be dispensed with, since the heat exchangers 270 themselves already have a sound-damping effect.

The heat exchangers 270 serve to preheat combustion agent which is compressed in the compressor cylinders 260 by the compressor pistons 250 and conducted through a pressure line 255 to the combustion chamber 210. The compression takes place in this case in a known manner, by the fact that supply air is drawn in through supply lines 257 (numbered as an example) by the compressor pistons 250 and compressed in the compressor cylinders 260. Known and readily appropriately utilizable valve systems are used to this end.

As is directly apparent from FIG. 2, the axial-piston engine 201 has two heat exchangers 270, both of which are situated axially in reference to the axial-piston engine 201. Through this arrangement, the paths which the exhaust gas must traverse through the exhaust gas channels 225, in each instance to the heat exchangers 270 can be reduced significantly, compared to state-of-the-art axial-piston engines. The result of this is that in the end the exhaust gas reaches the respective heat exchanger 270 at a significantly higher temperature, so that in the end the combustion agent can also be preheated to correspondingly higher temperatures. In practice, it has been found that at least 20% of fuel can be saved through such a configuration. It is assumed in this connection that savings of up to 30% or more are even possible by means of an optimized design.

In this connection it is understood that the efficiency of the axial-piston engine 201 can be increased through additional measures. For example, the combustion agent can be used in a known manner to cool or thermally insulate the combustion chamber 210, whereby its temperature can be increased still further before it enters the combustion chamber 210. Let it be emphasized here that the corresponding tempering can be limited on the one hand only to components of the combustion agent, as is the case in the present exemplary embodiment in reference to combustion air. It is also conceivable to apply water to the combustion air already before or during the compression; this is also readily possible afterwards, however, for example in the pressure line 255.

Especially preferably, the application of water to the compressor cylinder 260 takes place during an intake stroke of the corresponding compressor piston 250, which results in isothermal compression, or compression as close as possible to isothermal compression. As is directly apparent, each working cycle of the compressor piston 250 comprises an intake stroke and a compression stroke, wherein during the intake stroke combustion agent enters the compressor cylinder 260, which is then compressed, i.e., compressed, during the compression stroke, and conveyed into the pressure line 255. By applying water during the intake stroke, a uniform distribution of the water can be ensured in an operationally simple manner.

It is likewise conceivable to temper the fuel accordingly, wherein this is not absolutely necessary, since the quantity of fuel is usually relatively small in relation to the combustion air, and thus can be brought to high temperatures very quickly.

Likewise the application of water into the pressure line 255 can take place in this configuration, wherein inside the heat exchanger the water is mixed uniformly with the combustion agent by appropriate deflection of the flow. The exhaust gas channel 225 can also be selected for the application of water or another fluid, such as fuel or means for exhaust gas post-treatment, in order to guarantee homogeneous intermixing inside the heat exchanger 270. The configuration of the shown heat exchanger 270 further permits the post-treatment of the exhaust gas in the heat exchanger itself, wherein heat released by the post-treatment is supplied directly to the combustion agent present in the pressure line 255. A water trap, not depicted, which returns the condensed water present in the exhaust gas to the axial-piston engine 201 for renewed application, is situated in the outlet 227. The water trap can be designed in connection with a condenser. Furthermore, the use is possible in similarly designed axial-piston engines, wherein the other advantageous features on the axial-piston engine 201 or on similar axial-piston engines are advantageous even without use of a water trap in the outlet 227.

The axial-piston engine 301 depicted in FIG. 3 corresponds in its construction and in its manner of functioning essentially to the axial-piston engine 201 according to FIGS. 1 and 2. For this reason we will dispense with a detailed description, wherein assemblies in FIG. 3 that work similarly are also provided with similar reference labels and differ from one another only in the first digit. The axial-piston engine 301 also has a central combustion chamber 310, from which working medium in the working cylinder 320 can be conducted via shot channels 315 (numbered as an example) according to the working sequence of the axial-piston engine 301. After the working medium has performed its work, it is fed via exhaust gas channels 325 to heat exchangers 370, in each instance.

In this case the axial-piston engine 301, in contrast to the axial-piston engine 201, has one heat exchanger 370 each for exactly two working cylinders 320, whereby the length of the channels 325 can be reduced to a minimum. As is directly apparent, in this exemplary embodiment the heat exchangers 370 are partially inserted into the housing body 305 of the axial-piston engine 301, which leads to an even more compact construction than the construction of the axial-piston engine 201 according to FIGS. 1 and 2. In this case, the measure of how far the heat exchangers 370 can be inserted into the housing body 305 is limited by the possibility of the arrangement of other assemblies, such as, for example, a water cooling system for the working cylinders 220.

The axial-piston engine 401 depicted in FIG. 4 also corresponds essentially to the axial-piston engines 201 and 301 according to FIGS. 1 through 3. Accordingly, identically or similarly working assemblies are also labeled similarly, and differ only in the first digit. Accordingly, in other respects a detailed explanation of the mode of operation will also be dispensed with for this exemplary embodiment, since that was already done in reference to the axial-piston engine 201 according to FIGS. 1 and 2.

The axial-piston engine 401 also includes a housing body 405, on which a continuously working combustion chamber 410 with two combustion air inputs (not illustrated here), six working cylinders 420 and six compressor cylinders 460 are provided. In this case the combustion chamber 410 is connected via shot channels 415 to the working cylinders 420, in each instance, so that working medium can be fed to the working cylinders 420 corresponding to the timing rate of the axial-piston engine 401.

The shot channels 415 can be opened or closed by means of control pistons, not shown further here. The control pistons are driven and controlled by a respective control drive, wherein a compensating force directed counter to a combustion chamber pressure further acts additionally on each of the control pistons. In addition, the control pistons are situated in a pressure space, in which a pressure corresponding substantially to the combustion chamber pressure is adjusted. Hereby particularly simple sealing at the respective control piston is possible in the form of oil scraping. An adequate amount of oil is guaranteed at the control pistons, in that each of the control pistons is spray-cooled constantly with oil. Thus, besides the cooling, good lubrication and sealing at the respective control piston is always assured. The control pistons are formed in lightweight construction from aluminum and at least on the combustion chamber side have burning protection of iron, whereby they are designed to be very temperature-stable.

After its work is done, the working medium leaves the working cylinders 420 through exhaust gas channels 425, which lead to heat exchangers 470, in each instance, wherein these heat exchangers 470 are arranged identically to the heat exchangers 270 of the axial-piston engine 201 according to FIGS. 1 and 2 (see in particular FIG. 2). The working medium leaves the heat exchangers 470 through outlets 427 (numbered as an example).

Situated in the working cylinders 420 and the compressor cylinders 460 are working pistons 430 and compressor pistons 450, respectively, which are connected with one another by means of a rigid connecting rod 435. The connecting rod 435 includes in a known manner a curved track 440, which is provided on a spacer 424, which ultimately drives an output shaft 441.

In this exemplary embodiment also, combustion air is drawn in through supply lines 457 and compressed in the compressor cylinders 460, in order to be applied via pressure lines 455 to the combustion chamber 410, whereby the measures named in the case of the aforementioned exemplary embodiment can likewise be provided, depending on the concrete implementation.

In addition, in the case of the axial-piston engine 401 the pressure lines 455 are connected with one another via a ring channel 456, whereby a uniform pressure in all pressure lines 455 can be guaranteed in a known manner. Between the ring channel 456 and each of the pressure lines 455 valves 485 are provided, whereby the supply of combustion agent can be regulated or set by the pressure lines 455. Furthermore, a combustion agent reservoir 480 is connected to the ring channel 456 via a reservoir line 481, in which a valve 482 is likewise situated.

The valves 482 and 485 can be opened or closed, depending on the operating state of the axial-piston engine 401. Thus it is conceivable, for example, to close one of the valves 485 when the axial-piston engine 401 needs less combustion agent. It is also conceivable to partially close all valves 485 in such operating situations, and to allow them to operate as throttles. The surplus of combustion agent can then be fed to the combustion agent reservoir 480 when valve 482 is open. The latter is also possible in particular when the axial-piston engine 401 is running under deceleration, i.e., when no combustion agent at all is needed, but rather it is being driven via the output shaft 441. The surplus of combustion agent caused by the movement of the compressor pistons 450 that occurs in such an operating situation can likewise readily be stored in the combustion agent reservoir 480.

The combustion agent stored in this way can be fed supplementally to the axial-piston engine 401 as needed, i.e., in particular in driving off or acceleration situations, as well as for starting, so that a surplus of combustion agent is provided without additional or more rapid movements of the compressor pistons 450.

The valves 482 and 485 can also be dispensed with, if appropriate, to guarantee the latter. Foregoing such valves for prolonged storage of compressed combustion agent seems little suited, due to unavoidable leakage.

In an alternative embodiment to the axial-piston engine 401, the ring channel 456 can be dispensed with, wherein the outlets of the compressor cylinders 460 are then combined corresponding to the number of pressure lines 455—possibly by means of a section of ring channel. With a design of this sort it may possibly make sense to connect only one of the pressure lines 455, or not all pressure lines 455 to the combustion agent reservoir 480, or to not provide them as connectible. Such a design indeed means that not all compressor pistons 450 can fill the combustion agent reservoir 480 during deceleration. On the other hand, sufficient combustion agent is then available to the combustion chamber 410 so that combustion can be maintained without additional regulation or control system measures. Simultaneously with this, the combustion agent reservoir 480 is filled by means of the other compressor pistons 450, so that combustion agent is stockpiled accordingly and is available immediately, in particular for starting, driving off or acceleration phases.

It is understood that the axial-piston engine 401, in a different design variant not shown explicitly here, can be equipped with two combustion agent reservoirs 480, wherein the two combustion agent reservoirs 480 can then also be charged with different pressures, so that it is always possible with the two combustion agent reservoirs 480 to work with different pressure intervals in real time. Preferably a pressure regulating system is provided in this case, which sets a first lower pressure limit and a first upper pressure limit for the first combustion agent reservoir 480, and a second lower pressure limit and a second upper pressure limit for the second combustion agent reservoir (not shown here), inside which each combustion agent reservoir 480 is charged with pressures, wherein the first upper pressure limit is below the second upper pressure limit and the first lower pressure limit is below the second lower pressure limit. Specifically, the first upper pressure limit can be set lower than or equal to the second lower pressure limit.

Not shown in FIGS. 1 through 4 are temperature sensors for measuring the temperature of the exhaust gas or in the combustion chamber. For such temperature sensors, all temperature sensors can be considered which can operationally reliably measure temperatures between 800° C. and 1,100° C. In particular, if the combustion chamber comprises a precombustion chamber and a main combustion chamber, the temperature of the precombustion chamber can also be measured by means of such temperature sensors. In this respect, the axial-piston engines 201, 301 and 401 described above can each be regulated by means of the temperature sensors in such a way that the exhaust gas temperature when leaving the working cylinders 220, 320, 420 is approximately 900° C., and the temperature in the precombustion chamber—if present—is approximately 1,000° C.

In the case of the other axial-piston engine 501 shown according to the depiction in FIG. 5, such temperature sensors are present respectively as input sensors in the form of a prechamber temperature sensor 592 and two exhaust gas temperature sensors 593 of a combustion chamber regulating system (not shown explicitly here), and are depicted schematically accordingly.

In particular by means of the prechamber temperature sensor 592—which in this exemplary embodiment can also be referred to as preburner temperature sensor 592, due to its proximity to a preburner 517 of the other axial-piston engine 501—a meaningful value concerning the quality of combustion or with regard to the running stability of the other axial-piston engine 501 is ascertained. For example, a flame temperature can be measured in the preburner 517, in order to be able to regulate different operating states in the other axial-piston engine 501 by means of a combustion chamber regulating system.

By means of the exhaust gas temperature sensors 593, which are positioned at outlets or exhaust gas channels 525 of the respective working cylinder 520, specifically the operating state of the combustion chamber 510 can be checked cumulatively and regulated if necessary, so that optimal combustion of the combustion agent is always ensured.

Otherwise, the construction and operating principle of the other axial-piston engine 501 correspond to those of the previously described axial-piston engines. In this respect, the other axial-piston engine 501 has a housing body 505, on which a continuously working combustion chamber 510, six working cylinders 520 and six compressor, cylinders 560 are provided.

The combustion chamber 510 has two combustion air inputs not shown in more detail here. Combustion air at different temperatures for these two combustion air inputs can be supplied by means of heat exchangers connected appropriately on the input side (not depicted explicitly here), for example by passing a first combustion air through the heat exchanger in crossflow and/or counterflow to an exhaust gas, but not a second combustion air for the second combustion air input.

Inside the combustion chamber 510, combustion agent can be both ignited and burned, wherein the combustion chamber 510 can be charged with combustion agent in the manner described above. Advantageously, the other axial-piston engine 501 works with a two-stage combustion system, to which end the combustion chamber 510 has the previously already mentioned preburner 517 and a main burner 518. Combustion agent can be injected into the preburner 517 and into the main burner 518, wherein a proportion of combustion air of the axial-piston engine 501, which specifically in this exemplary embodiment can be smaller than 15% of the total combustion air, can also be introduced in particular into the preburner 517.

The preburner 517 has a smaller diameter than the main burner 518, wherein the combustion chamber 510 has a transition area that comprises a conical chamber 513 and a cylindrical chamber 514.

To supply combustion agent and combustion air, on the one hand a main nozzle 511 and on the other hand a processing nozzle 512 discharge into the combustion chamber 510, in particular into the associated conical chamber 513. By means of the main nozzle 511 and the processing nozzle 512, combustion agent or combustible substance can be injected into the combustion chambers 510, wherein in this exemplary embodiment the combustion agent injected by means of the processing nozzle 512 are already being mixed or are already mixed with combustion air

The main nozzle 511 is oriented essentially parallel to a main combustion direction 502 of the combustion chamber 510. Furthermore, the main nozzle 511 is oriented coaxially to an axis of symmetry 503 of the combustion chamber 510, wherein the axis of symmetry 503 lies parallel to the main combustion direction 502.

Furthermore, the processing nozzle 512 is situated at an angle (not sketched explicitly here for the sake of clarity) with respect to the main nozzle 511, so that a jet direction 516 of the main nozzle 511 and a jet direction 519 of the processing nozzle 512 intersect at a mutual point of intersection within the conical chamber 513.

Combustible substance or fuel is injected from the main nozzle 511 into the main burner 518 in this exemplary embodiment without additional air supply, wherein the combustible substance can already be preheated and ideally thermally decomposed in the main burner 518. To this end, the volume of combustion air corresponding to the quantity of combustible substance flowing through the main nozzle 511 is introduced into a combustion space 526 behind the preburner 517 or the main burner 518, to which end a separate combustion air supply system 504 is provided, which discharges into the combustion space 526.

To this end, the separate precombustion air supply system 504 is connected to a process air supply system 521, wherein a further combustion air supply system 522 can be supplied with combustion air from the separate combustion air supply system 504, which in this case supplies a perforated ring 523 with combustion air. The perforated ring 523 is assigned in this case to the processing nozzle 512. In this respect, the combustible substance injected with the processing nozzle 512, mixed additionally with process air, can be injected into the preburner 517 or into the conical chamber 513 of the main burner 518.

In addition, the combustion chamber 510, in particular the combustion space 526, includes a ceramic assembly 506, which is advantageously air-cooled. The ceramic assembly 506 includes in this case a ceramic combustion chamber wall 507, which in turn is surrounded by a profiled pipe 508. Around this profiled pipe 508 extends a cooling air chamber 509, which is connected to the process air supply system 521 by means of a cooling air chamber supply system 524.

The known working cylinders 520 carry corresponding working pistons 530, which are mechanically connected to compressor pistons 550 by means of connecting rods 535, in each instance.

In this exemplary embodiment the connecting rods 535 include connecting rod running wheels 536, which run along a curved track 540, while the working pistons 530 or the compressor pistons 550 are moved. An output shaft 541 is thereby set in rotation, which is connected to the curved track 540 by means of a driving curved track carrier 537. Power produced by the axial-piston engine 501 can be delivered via the output shaft 541.

In a known way, by means of the compressor pistons 550 compression of the process air occurs, also including injected water if appropriate, which can be used if necessary for additional cooling. If the application of water or of steam occurs during an intake stroke of the corresponding compressor piston 550, isothermal compression of the combustion agent can specifically be promoted. An application of water that accompanies the intake stroke can ensure an especially uniform distribution of the water within the combustion agent, in an operationally simple manner.

Exhaust gases can be cooled significantly more deeply thereby, if necessary, in one or more heat exchangers not depicted here, if the process air is to be prewarmed by means of one or more such heat exchangers and carried to the combustion chamber 510 as combustion agent, as described for example already in detail in the exemplary embodiments already explained above with regard to FIGS. 1 through 4. The exhaust gases can be fed to the heat exchanger or heat exchangers via the exhaust gas channels 525 named above, wherein the heat exchangers are arranged axially in reference to the other axial-piston engine

In addition, the process air can be further prewarmed or heated through a contact with additional assemblies of the axial-piston engine 501 that must be cooled, as has also already been explained. The process air compressed and heated in this way is then applied to the combustion chamber 510 in the manner that has already been explained, whereby the efficiency of the other axial-piston engine 501 can be further increased.

Each of the working cylinders 520 of the axial-piston engine 501 is connected via a shot channel 515 to the combustion chamber 510, so that an ignited combustion agent mixture or fuel-air mixture can pass out of the combustion chamber 510 via the shot channels 515 into the respective working cylinder 520 and can perform work on the working pistons 530 as a working medium.

In this respect, the working medium flowing from the combustion chamber 510 can be fed via at least one shot channel 515 successively to at least two working cylinders 520, wherein for each working cylinder 520 one shot channel 515 is provided, which can be closed and opened by means of a control piston 531. Advantageously, the control piston 531 has opening and closing times different from one another, wherein the control piston 531 ideally can be closed faster than opened. In this respect, the operation of the axial-piston engine 501 can be adapted extremely flexibly to different requirements.

The number of the control pistons 531 of the other axial-piston engine 501 is prescribed by the number of the working cylinders 520. Closing the shot channel 515 is done in this case by means of the control piston 531, including its control piston cover 532. The control piston 531 is driven by means of a control drive with a control piston curved track 533, wherein a spacer 534 for the control piston curved track 533 to the drive shaft 541 is provided, which also serves in particular for thermal decoupling. In the present exemplary embodiment of the other axial-piston engine 501, the control piston 531 can perform an essentially axially directed stroke motion 543. To this end, each of the control pistons 531 is guided by means of sliders, not further labeled, which are supported in the control piston curved track 533, wherein the sliders each have a safety cam that runs back and forth in a guideway, not further labeled, and prevents the control piston 531 from turning.

Advantageously, the control piston 531, besides the force applied by the control drive, is additionally subjected further to a compensating force directed counter to a combustion chamber pressure, so that the control drive can be designed with particularly simple construction. On the basis of the existing compressor cylinder pressure, the compensating force is generated pneumatically with particularly little construction complexity.

In particular, sealing at the respective control piston 531 can be undertaken extremely simply when the control piston 531 is situated in a pressure space, in which similar pressure conditions exist as in the combustion chamber 510. In this case, ideally adequate seal tightness is already assured by means of pure oil scraping.

In order to be able to reduce the moving masses even with respect to the present control piston 531, the control piston 531 likewise has cross struts and is made from aluminum, at least with respect to its piston stem. In the region of the piston bottom, however, the control piston 531 consists of an iron alloy on the combustion chamber side, in order that it can better withstand even very high combustion agent temperatures.

Alternatively, the control piston 531 can also be made of a steel alloy, so that it is even more improbable that strength and/or stiffness problems as well as thermal difficulties can occur than with respect to an aluminum alloy.

Since the control piston 531 comes into contact in the area of the shot channel 515 with the hot working medium from the combustion chamber 510, it is advantageous if the control piston 531 is water-cooled. To this end, the other axial-piston engine 501 has a water cooling system 538, in particular in the area of the control piston 531, wherein the water cooling system 538 includes inner cooling channels 545, middle cooling channels 546 and outer cooling channels 547. Well cooled in this way, the control piston 531 can be moved operationally reliably in a corresponding control piston cylinder.

Furthermore, the surfaces of the control piston 531 in contact with combustion agent are reflective or provided with a reflective coating, so that heat input occurring via heat radiation into the control pistons 531 is minimized. The further surfaces of the shot channels 515 and of the combustion chamber 510 in contact with combustion agent are also provided in this exemplary embodiment (likewise not depicted) with a coating having high spectral reflectivity. This is true in particular for the combustion chamber floor (not explicitly numbered), but also for the ceramic combustion chamber wall 507. It is understood that this configuration of the surfaces in contact with combustion agent can be present in an axial-piston engine even independently of the other configuration features. It is understood that, in modified embodiments, further assemblies can also be reflective or else the aforementioned reflectivenesses can be omitted at least partly.

The shot channels 515 and the control pistons 531 can be provided using especially simple construction, if the other axial piston engine 501 has a shot channel ring 539. In this case the shot channel ring 539 has a middle axis, around which in particular the parts of the working cylinders 520 and of the control piston cylinders are arranged concentrically. Between each working cylinder 520 and control piston cylinder a shot channel 515 is provided, wherein every shot channel 515 is spatially connected to a cutout (not labeled here) of a combustion chamber floor 548 of the combustion chamber 510. In this respect, the working medium can pass from the combustion chamber 510 via the shot channels 515 into the working cylinders 520 and there perform work, by means of which the compressor pistons 550 can also be moved. It is understood, that coatings and inserts can also be provided, depending on the concrete configuration, in order to protect in particular the shot channel ring 539 or its material from direct contact with corrosive combustion products or with excessively high temperatures. The combustion chamber floor 548 in turn can also be provided on its surface with a further ceramic or metallic coating, especially a reflective coating, which on the one hand reduces the heat radiation emerging from the combustion chamber 510 by increasing the reflectivity and on the other hand reduces the heat conduction by reducing the thermal conductivity.

It is understood that the other axial-piston engine 501 for example can likewise be equipped with at least one combustion agent reservoir and corresponding valves, although this is not shown explicitly in the concrete exemplary embodiment according to FIG. 6. In addition, in the case of the other axial-piston engine the combustion agent reservoir can be provided in a double version, in order to be able to store compressed combustion agent at different pressures. The two existing combustion agent reservoirs can be connected in this case to corresponding pressure lines of the combustion chamber 510, wherein the combustion agent reservoirs are fluid-connectible with or separable from the pressure lines by means of valves. Stop valves or throttle valves, or regulating or control valves, can be provided in particular between the working cylinders 520 or compressor cylinders 560 and the combustion agent reservoir. For example, the aforementioned valves can be opened or closed appropriately during driving-off or acceleration situations, as well as for starting, whereby a surplus of combustion agent can be made available to the combustion chamber 510, at least for a limited period of time. The combustion agent reservoirs are interconnected fluidically preferably between one of the compressor cylinders and one of the heat exchangers. The two combustion agent reservoirs are ideally operated at different pressures, in order thereby to be able to make very good use of the energy provided by the other axial-piston engine 501 in the form of pressure. To this end, the provided upper pressure limit and lower pressure limit at the first combustion agent reservoir can be set by means of an appropriate pressure regulating system below the upper pressure limits and lower pressure limits of the second combustion agent reservoir. It is understood that in this case work can be done on the combustion agent reservoirs with different pressure intervals.

Finally, it must also be remarked that application of water into the combustion agent circuit of the axial-piston engine 501 can take place even in other regions of the axial-piston engine 501, for example into the present combustion chamber 510, especially into the precombustion chamber and/or main combustion chamber of the combustion chamber 510. Ideally, such application of water is regulated by means of a combustion chamber regulation system, for example when the exhaust gas temperature is to be regulated hereby.

The further axial-piston engines depicted in FIGS. 6 and 7 correspond substantially to the axial-piston engine 501, so that in this respect a new explanation of the modes of action and operation is not needed. A substantial difference between the axial-piston engines from FIGS. 6 and 7 on the one hand and the axial-piston engine 501 on the other hand is the cooling of the combustion space 1326 charged with combustion agent via the cylindrical chamber 1314, which in the depicted axial-piston engines takes place supplementally via water. It is understood that water cooling of this or similar sort can also be provided in the axial-piston engine 501 or the other axial-piston engines depicted here. To this end, each of the two axial-piston engines has a water chamber 1309A, which surrounds the combustion space 1326 and is fed with liquid water via a supply line. To this end, water with combustion chamber pressure is supplied in each instance via the supply line, not numbered.

This water is applied via branch channels in each instance to a ring channel 1309D, which is in contact with a steel pipe (not numbered), which for its part surrounds the profiled pipe 1308 of the respective combustion space 1326 and is dimensioned such that a ring gap (not numbered) remains in each instance both between the profiled pipe 1308 and the steel pipe on the one hand and also between the steel pipe and the housing part containing the branch channels on the other hand, and such that the two ring gaps are connected with one another via the end of the steel pipe facing away from the ring channel 1309D. It is understood in this case that the pipes can also be formed of a material other than steel.

In the depicted axial-piston engines, further ring channels 1309E, which on the one hand are connected with the respective radially inward ring gap and on the other hand open via channels 1309F into a ring nozzle (not numbered), which leads into the respective combustion space 1326, are provided above the profiled pipes 1308. In this case the ring nozzle is aligned axially relative to the combustion chamber wall or to the ceramic combustion chamber wall 1307, so that the water can protect the ceramic combustion chamber wall 1307 even on the combustion chamber side.

It is understood that the water can vaporize in each instance on its way from the supply line to the combustion chamber 1326 and that the water can be provided if necessary with further additives. It is also understood that if necessary the water can be recovered from the exhaust gas of the respective axial-piston engine and reused.

The axial-piston engine otherwise corresponding substantially to the exemplary embodiments described above includes a combustion space 1326, control pistons 1331, shot channels 1315 and working pistons 1330. The combustion space 1326 situated with rotational symmetry around the axis of symmetry 1303 has, as described above, a ceramic assembly 1306 with a ceramic combustion chamber wall 1307 and a profiled steel pipe 1308. The main combustion direction 1302, in which combustion agent flows in the direction of the shot channels 1315 and working cylinders 1320, extends along the axis of symmetry 1303. The combustion space 1326 is separated from the working cylinder 1320 by the control pistons 1331, situated parallel to the axis of symmetry 1303. Because of the oscillating movement of the control pistons 1331 along their longitudinal axes 13153, a shot channel 1315 belonging to a control piston is periodically released in each instance, as soon as the working piston 1330 present in the working cylinder 1320 executes a movement in the direction of its top dead point or is already positioned at the top dead point. The shot channel 1315 has the axis of symmetry 1315A, along which a guide face 1332A is aligned. The guide face 1332A aligned parallel to this axis of symmetry 1315A is therefore flush with a wall of the shot channel 1315, as soon as the control piston 1331 is at its bottom dead point, and hereby permits deflection-free flow of the combustion agent in the direction of the working cylinder 1320. In turn, a guide-face sealing face 1332E is aligned parallel to the guide face 1332A, so that this guide-face sealing face 1332E approximately closes upon the guide face 1332A, as soon as the control piston 1331 has reached its top dead point. The cylindrical jacket face of the control piston 1331 further closes upon a stem sealing face 1332D and thus reinforces the sealing action between the combustion space 1326 and the working cylinder 1320. In addition, the control piston 1331 has an impact face 1332B, which is aligned approximately at right angles to the axis of symmetry of the shot channel 1315A. This alignment therefore takes place approximately normal relative to the flow direction of the combustion agent, when this emerges from the combustion space 1326 and enters the shot channel 1315. Consequently, this part of the control piston 1331 is loaded as little as possible by a heat flow, since the impact face 1332B has a minimum surface relative to the combustion space 1326.

The control piston 1331 is controlled via the control piston curved track 1333. This control piston curved track 1333 does not necessarily have a sinusoidally shaped profile. A control piston curved track 1333 deviating from sinusoidal shape makes it possible to hold the control piston 1331 for a specified time interval at the respective top or bottom dead point and hereby, on the one hand, to keep the opening cross section at its maximum possible while the shot channel 1315 is open and, on the other hand, to keep the thermal stress of the control piston surface as a consequence of a critical flow velocity of the combustion agent as low as possible during opening and closing of the shot channel, in that a maximum possible opening speed at the instant of opening is selected via the configuration of the control piston curved track 1333.

The exemplary embodiment depicted in FIG. 6 also has a control piston oil space 1362 present in the control piston 1331, which serves the control piston seal 1363 with oil or receives oil flowing back again from the control piston seal 1363. The control piston oil space 1362 is fed via the pressure-oil circuit 1361. The bottom side of the control piston 1331 points in the direction of the control chamber 1364, formed as the pressure space. At the same time, the control chamber 1364 collects oil emerging from the control piston 1331 and the pressure-oil circuit 1361. It is also possible optionally to charge the inner cooling channels 1345 with oil via the pressure-oil circuit 1361 instead of via a water circuit, in order to cool the bottom side of the combustion space 1326.

In the exemplary embodiment depicted in FIG. 7, a first control chamber seal 1365 and a second control chamber seal 1366 designed as a radial shaft seal ring are provided, which seal the control chamber 1364, which may be at higher pressure, relative to the rest of the axial-piston engine, which is under approximately environmental pressure. The first control chamber seal 1365 and second control chamber seal 1366 seal the control chamber 1364 via a sealing sleeve 1367. This sealing sleeve 1367 is seated by means of a press fit on a rotating central shaft of the axial-piston engine, which partly contains the pressure-oil circuit 1361. As is immediately obvious, the sealing sleeve 1367 can also be connected with the rotating shaft in a different manner. A material connection or an additional seal between the shaft and the sealing sleeve 1367 is also conceivable. As is further immediately obvious, these seals are seated on a relatively small radius, so that efficiency losses can be minimized. Likewise these seals are situated in a relatively cool region of the axial-piston engine, so that conventional seals can be employed here.

FIG. 7 also shows a further configuration of the control-piston surfaces used for sealing the shot channels 1315. Therein it is evident that the impact face 1332B does not necessarily have to be a planar face, but can also be a segment of a spherical, cylindrical or conical surface and thus, for example have rotationally symmetric shape relative to the axis of symmetry 1303. The guide face 1332A and the guide-face sealing face 1332E can also have shape different from planar. In this case FIG. 7 shows a configuration of the guide face 1332A and of the guide-face sealing face 1332E, wherein these faces represent an angled line, at least in a sectional plane.

The surfaces of the control piston 1331 depicted in this embodiment, such as, for example, the guide face 1332A or the impact face 1332E, as well as the sealing faces, such as the guide-face sealing face 1332E or the stem sealing face 1332D, are also reflective, in order to suppress or minimize heat losses occurring via the control piston due to heat radiation. The applied reflectiveness of these surfaces can furthermore also consist of a ceramic coating, which reduces the thermal conductivity or the heat transmission to the control piston. Just as the surfaces of the control piston 1331, the surface of the combustion chamber floor 1348 (shown as an example in FIG. 6) is reflective, in order to minimize heat loss in the wall. In addition, internal cooling channels, which remove heat from the combustion space 1326 optionally with water or oil, are situated on the bottom side of the combustion chamber floor 1348.

The cooling chamber 1334 of the control piston 1331 depicted in FIG. 7 is partly filled with a metal, sodium in this exemplary embodiment, present in liquid form at operating temperature of the axial-piston engine, which can remove heat from the surfaces of the control piston by convection and heat conduction and discharge it to the oil present in the pressure-oil circuit 1361.

The pressure-oil circuit 1361 supplying the control piston 1331 with oil is schematically depicted in FIG. 8. Therein the interconnection of the engine-oil circuit 2002 with the pressure-oil circuit 2003 and the compressor stage 2011 inside the oil circuit 2001 is depicted. The pressure-oil circuit 2003, which can be closed via the charging valve 2016 and equalizing valve 2026, contains essentially a pressure-oil sump 2022, from which the pressure-oil pumps 2021 can draw oil via the second inflow 2033 and the common inflow 2034 and make it available to the control chamber 2023 via the second supply line 2025 The oil circuit is then closed by the oil return flow 2031, in that the returning oil is supplied back to the pressure-oil sump 2022 via this oil return flow 2031. Provided the pressure-oil circuit 2003 is closed relative to its environment, the pressure-oil pump 2021 needs only minimum power consumption to convey the oil. In this case only the flow losses caused by the circulation of the oil in the pressure-oil circuit 2003 are applied via the pump power. The force needed for compensation of a combustion chamber pressure acting on the control piston 1331 is compensated via a pressure applied by the compressor stage 2011. To this end the compressor stage 2011 is likewise connected with the control chamber 2023 via the inflow 2035 and the pressure lines 2015 and 2030. The charging valve 2016 is situated between the supply line 2035 and the pressure line 2015, in order to separate the pressure-oil circuit 2003 from the compressor stage 2011, as soon as no further charging of the pressure-oil circuit 2003 is necessary. In this case the charging valve 2016 is designed as a multi-way valve. The activation of the charging valve 2016 takes place in addition via the control line 2036, which likewise is connected with the compressor stage 2011 via the inflow 2035. In one embodiment, the control takes place in such a way that the charging valve 2016 connects the inflow 2036 with the pressure line 2015 when the compressor pressure applied by the compressor stage corresponds to or exceeds the pressure present in the control chamber 2023. A configuration of the charging valve 2016 with a specified opening pressure is also possible. For example, the valve can also be adjusted in such a way that it opens only at a compressor pressure of approximately 30 bar. It is also possible that the charging valve 2016 is activated via performance characteristics resident in the control instrument of the axial-piston engine and thus opens it in dependence on load or speed of revolution. By dependence on load or speed of revolution, the operating state of the axial-piston engine is meant in this case.

In this embodiment, the filling of the pressure-oil circuit 2003 takes place by switching of the equalizing valve 2026, which is connected via the control line 2024 with the pressure-oil sump 2022, so that oil can be supplied from the engine-oil sump 2012 via the first inflow 2032 to the pressure-oil circuit 2003, at least at minimum oil level in the pressure-oil sump 2022, as long as the operating point of the axial-piston engine permits this. The return-flow valve 2027 situated in the first inflow 2032 prevents inadvertent emptying of the pressure-oil circuit 2003 into the engine-oil circuit 2002, unless the pressure-oil pump 2021 can generate a sufficient pressure gradient between the pressure-oil circuit 2003 and the engine-oil circuit 2002.

An oil scraper 2028 is likewise connected between the pressure lines 2015 and 2030. On the one hand this oil scraper 2028 functions to supply the control chamber 2023 with oil-free compressed air, and on the other hand it is also possible that depressurization of the second partial circuit 2003 can take place via the charging valve 2016 and in this way oil-free air is returned to the compressor stage 2011. In the case of a backflow from the pressure-oil circuit 2003 into the compressor stage 2011, the spontaneous ignition of the combustion agent enriched with oil during compression or after compression can therefore be effectively prevented. In this case the return flow 2029 connects the oil scraper 2028 with the pressure-oil sump 2022.

The pressure-oil sump 2022 is additionally provided with means for determining an oil level, which are connected via a control line 2024 with the equalizing valve 2026. In this case the equalizing valve 2026 has the task of connecting the engine-oil circuit 2002 with the pressure-oil circuit 2002 or with the engine-oil sump 2012 of the engine-oil circuit 2002. The equalizing valve 2026 therefore further has the task of supplying the pressure-oil circuit 2003 with a sufficiently large amount of oil, in that the pressure-oil pump 2021 can draw deficient oil from the engine-oil sump 2012 via the first inflow 2032. Preferably the connection of the engine-oil circuit 2002 with the pressure-oil circuit 2003 via the equalizing valve 2026 takes place only when the pressure level in the pressure-oil circuit 2003 is particularly low, in order to prevent increased power consumption of the pressure-oil pump 2021 due to a greater pressure difference.

FIG. 9 shows a heat exchanger head plate 3020 which is suitable for use for a heat exchanger for an axial-piston engine. For the purpose of mounting on and connection to an output manifold of an axial-piston engine, the heat exchanger head plate 3020 includes a flange 3021 with corresponding bore holes 3022 arranged in a circle in the radially outer area of the heat exchanger head plate 3020. In the radially inner area of the flange 3021 is the matrix 3023, which has numerous bore holes designed as pipe seats 3024 for receiving pipes.

The entire heat exchanger head plate 3020 is preferably made from the same material from which the pipes are also made, in order to ensure that the thermal expansion coefficient is as homogeneous as possible in the entire heat exchanger and that thermal stresses in the heat exchanger are thereby minimized. Cumulatively to this, the jacket housing of the heat exchanger can likewise be produced from a material that corresponds to the heat exchanger head plate 3020 or to the pipes. The pipe seats 3024 can be designed for example with a fit such that the pipes mounted in these pipe seats 3024 are inserted by means of a press fit.

Alternatively to this, the pipe seats 3024 can also be designed so that a clearance fit or a transition fit is realized. In this way, mounting of the pipes in the pipe seats 3024 can also take place by means of a materially bonded connection rather than a frictional connection. The material connection is preferably effected in this case by welding or soldering, wherein a material corresponding to the heat exchanger head plate 3020 or to the pipes is used as the soldering or welding material. This also has the advantage that thermal stresses in the pipe seats 3024 can be minimized by homogeneous thermal expansion coefficients.

It is also possible in the case of this accomplishment to install pipes in the pipe seats 3024 by press fit, and in addition to solder or weld them. Through this type of installation, leak tightness of the heat exchanger can also be ensured, if different materials are used for the pipes and the heat exchanger head plate 3020, since the possibility exists that due to the very high occurring temperatures of over 1,000° C. use of only a press fit can fail under certain circumstances because of different thermal expansion coefficients.

FIG. 10 shows a schematic sectional view of a gas-exchange valve 1401 with a valve spring 1411 and an impact spring 1412. In this case the gas-exchange valve 1401 is designed as an automatically opening valve without cam control, which opens at a specified pressure difference, wherein the cylinder internal pressure during an intake process of the cylinder is lower than the pressure in the inlet channel, from which the corresponding cylinder draws a combustion agent. The gas-exchange valve 1401 preferably finds use as an inlet valve in the compressor stage. In this case the valve spring 1411 makes a closing force available to the gas-exchange valve 1401, by means of which the opening time can be determined via the configuration of the valve spring 1411. The valve spring 1411, which engages around the valve stem 1404 of the gas-exchange valve, is seated in this case in a valve guide 1405 and is braced against the valve spring plate 1413.

The valve spring plate 1413 in turn is fixed positively on the valve stem 1404 of the gas-exchange valve 1401 with at least two key pieces 1414.

The configuration of the valve spring 1411, wherein this valve spring 1411 is designed precisely such that opening of the gas-exchange valve 1401 already takes place at small pressure differences, can lead under certain operating conditions to the situation that the gas-exchange valve 1401 experiences such a high acceleration due to the pressure difference present at the valve plate 1402 that it leads to excessive opening of the gas-exchange valve 1401 beyond the defined valve stroke.

Upon opening of the gas-exchange valve 1402, the valve plate 1402 releases, at its valve seat 1403, a flow cross section that from a certain valve stroke on does not substantially increase further. The maximum flow cross section at the valve seat 1403 is usually defined via the diameter of the valve plate 1402. The stroke of the gas-exchange valve 1401 at maximum flow cross section corresponds approximately to one fourth of the diameter of the valve plate 1402 at its inner valve seat. Upon exceedance of the valve stroke or of the computed valve stroke at maximum flow cross section, on the one hand no further substantial increase of the air mass flow occurs at the flow cross section between valve seat 1403 and valve plate 1402, and on the other hand it is possible that the valve spring plate 1413 will come into contact with a fixed component of the cylinder head, for example the valve spring guide 1406 in this case, and thus that the valve spring plate 1413 or the valve spring guide 1406 will be destroyed.

In order to prevent or limit this excessive opening of the gas-exchange valve 1401, the valve spring plate 1403 comes up against the impact spring 1412, whereby the total spring force, consisting of the valve spring 1411 and the impact spring 1412, increases suddenly and the gas-exchange valve 1402 is subjected to strong deceleration. In this exemplary embodiment, the stiffness of the impact spring 1412 is chosen such that, at maximum opening speed of the gas-exchange valve 1401, the gas-exchange valve 1401 is retarded just strongly enough by coming up against the impact spring 1412 that no contact is established between moving components of the valve group, such as, for example, the valve spring plate 1413, and fixed components, such as, for example, the valve spring guide 1406.

The spring force applied in two stages in this embodiment further imparts the advantage that, during the closing process of the gas-exchange valve 1401, this gas-exchange valve 1401 is not accelerated excessively in the opposite direction and does not impact the valve seat 1403 with excessive speed in the valve plate 1402, since the valve spring 1411 responsible for opening and closing the gas-exchange valve 1401 is designed precisely such that it does not supply any excessively high spring forces.

FIG. 11 shows a further schematic sectional view of a gas-exchange valve 1401 with a valve spring 1411 and an impact spring 1412, in which a two-piece valve spring plate 1413 is used in combination with a bracing ring 1415. In this embodiment, the split valve spring plate 1413 is brought into contact with the valve stem 1404 without use of conical pieces 1414, and there it absorbs the spring forces of the valve spring 1411 and of the impact spring 1412 positively. In this case the bracing ring 1415 represents on the one hand a captive safeguard and on the other hand the bracing ring 1415 absorbs forces in radial direction as viewed from the axis of the valve stem. A retaining ring 1416 in turn secures the bracing ring 1415 against falling out.

In order further to achieve smooth opening and closing of the gas-exchange valve, gas-exchange valves 1401 according to this embodiment, i.e., for use in the compressor stage and as an automatically opening valve, are made from a light metal. In this case the lower inertia of a gas-exchange valve 1402 of light metal favors the rapid opening but also the rapid and gentle closing of the gas-exchange valve 1401. Also, the valve seat 1403 is preserved by the low inertia, since the gas-exchange valve 1401 in this embodiment does not release any excessively high kinetic energies during settlement into the valve seat 1403. The gas-exchange valve 1401 shown is preferably made of dural, a high-strength aluminum alloy, whereby the gas-exchange valve 1401 has adequately high strength despite its low density.

Reference labels

| | |
|---|---|
| 201 | axial piston engine |
| 205 | housing body |
| 210 | combustion chamber |
| 215 | shot channel |
| 220 | working cylinder |
| 225 | exhaust gas channel |
| 227 | outlet |
| 230 | working piston |
| 235 | connecting rod |
| 240 | curved track |
| 241 | output shaft |
| 242 | spacer |
| 250 | compressor piston |
| 255 | pressure line |
| 257 | supply line |
| 260 | compressor cylinder |
| 270 | heat exchanger |
| 301 | axial piston engine |
| 305 | housing body |
| 310 | combustion chamber |
| 315 | shot channel |
| 320 | working cylinder |
| 325 | exhaust gas channel |
| 370 | heat exchanger |
| 401 | axial piston engine |
| 405 | housing body |
| 410 | combustion chamber |
| 415 | shot channel |
| 420 | working cylinder |
| 425 | exhaust gas channel |
| 427 | outlet |
| 430 | working piston |
| 435 | connecting rod |
| 440 | curved track |
| 441 | output shaft |
| 442 | spacer |
| 450 | compressor piston |
| 455 | pressure line |
| 456 | ring channel |
| 457 | supply line |
| 460 | compressor cylinder |
| 470 | heat exchanger |
| 480 | combustion agent reservoir |
| 481 | reservoir line |
| 485 | valve |
| 501 | axial piston engine |
| 502 | main combustion direction |
| 503 | axis of symmetry |
| 504 | combustion air supply system |
| 505 | housing body |
| 506 | ceramic assembly |
| 507 | ceramic combustion chamber wall |
| 508 | profiled pipe |
| 509 | cooling air chamber |
| 510 | combustion chamber |
| 511 | main nozzle |
| 512 | processing nozzle |
| 513 | conical chamber |
| 514 | cylindrical chamber |
| 515 | shot channel |
| 516 | first jet direction |
| 517 | preburner |
| 518 | main burner |
| 519 | further jet direction |
| 520 | working cylinder |
| 521 | process air supply system |
| 522 | further combustion air supply system |
| 523 | perforated ring |
| 524 | cooling air chamber supply system |
| 525 | exhaust gas channel |
| 526 | combustion space |
| 530 | working piston |
| 531 | control piston |
| 532 | control piston cover |
| 533 | control piston curved track |
| 534 | spacer |
| 535 | connecting rod |
| 536 | connecting rod running wheels |
| 537 | driving curved track carrier |
| 538 | water cooling system |
| 539 | shot channel ring |
| 540 | curved track |
| 541 | output shaft |
| 543 | stroke motion |
| 545 | inner cooling channels |
| 546 | middle cooling channels |
| 547 | outer cooling channels |
| 548 | combustion chamber floor |
| 550 | compressor piston |
| 560 | compressor cylinder |
| 592 | prechamber temperature sensor |
| 593 | exhaust gas temperature sensor |
| 1302 | main combustion direction |
| 1303 | axis of symmetry |
| 1306 | ceramic assembly |
| 1307 | ceramic combustion chamber wall |
| 1308 | profiled steel pipe |
| 1309A | water chamber |
| 1309D | ring channel |
| 1309E | ring channel |
| 1309F | channel |
| 1314 | cylindrical chamber |
| 1315 | shot channel |
| 1315A | axis of symmetry of the shot channel |
| 1315B | longitudinal axis of the control piston |
| 1320 | working cylinder |
| 1326 | combustion space |
| 1330 | working piston |
| 1331 | control piston |
| 1332A | guide face |
| 1332B | impact face |
| 1332D | stem sealing face |
| 1332E | guide-face sealing face |
| 1333 | control piston curved track |
| 1334 | cooling chamber |
| 1345 | inner cooling channels |
| 1348 | combustion chamber floor |
| 1361 | pressure-oil circuit |
| 1362 | control piston oil space |
| 1363 | control piston seal |
| 1364 | control chamber |
| 1365 | first control chamber seal |
| 1366 | second control chamber seal |
| 1367 | sealing sleeve |
| 1401 | gas exchange valve |
| 1402 | valve plate |
| 1403 | valve seat |
| 1404 | valve stem |
| 1405 | valve guide |
| 1406 | valve spring guide |
| 1411 | valve spring |
| 1412 | impact spring |
| 1413 | valve spring plate |
| 1414 | conical piece |
| 1415 | bracing ring |
| 1415 | retaining ring |
| 2001 | oil circuit |
| 2002 | engine-oil circuit |
| 2003 | pressure-oil circuit |
| 2011 | compressor stage |
| 2012 | engine-oil sump |
| 2015 | pressure line |
| 2016 | charging valve |
| 2021 | pressure-oil pump |
| 2022 | pressure-oil sump |
| 2023 | control chamber |
| 2024 | oil level control line |
| 2025 | second supply line |
| 2026 | equalizing valve |
| 2027 | return-flow valve |
| 2028 | oil scraper |
| 2029 | return flow |
| 2030 | pressure line |
| 2031 | oil return flow |
| 2032 | first inflow |
| 2033 | second inflow |
| 2034 | common inflow |
| 2035 | inflow |
| 2036 | control line |
| 3020 | heat exchanger head plate |
| 3021 | flange |
| 3022 | mounting hole |
| 3023 | matrix |
| 3024 | pipe seat |

1-107. (canceled)

108. Axial-piston engine with at least one compressor cylinder, with at least one working cylinder and with at least one pressure line, through which compressed combustion agent is conducted from the compressor cylinder via a combustion chamber to the working cylinder, wherein the stream of combustion agent from the combustion chamber to the working cylinder is controlled via at least one control piston, which is driven by a control drive, wherein the control piston is wetted with oil, wherein the oil wetting the control piston is conducted in a separate oil circuit.

109. Axial-piston engine according to claim 108, comprising a main oil circuit for lubrication and/or cooling of assemblies of the axial piston engine, which is separated from the separate oil circuit.

110. Axial-piston engine according to claim 109, comprising an openable and closable connection between the main oil circuit and the separate oil circuit.

111. Axial-piston engine according to claim 108, wherein the control piston is spray-cooled.

112. Axial-piston engine according to claim 111, wherein the spray cooling takes place with oil.

113. Axial-piston engine according to claim 108, wherein an oil scraper is provided on the control piston.

114. Axial-piston engine according to claim 108, wherein the control piston is formed from iron or steel on the combustion chamber side.

115. Axial-piston engine according to claim 114, wherein the entire control piston is formed from iron or steel.

116. Axial-piston engine according to claim 114, wherein the control piston is otherwise formed from aluminum.

117. Axial-piston engine according to claim 108, wherein the control piston has a cavity filled with metal that is liquid at operating temperature of the axial-piston engine or a cavity filled with metal alloy that is liquid at operating temperature of the axial-piston engine.

118. Axial-piston engine according to claim 117, wherein the metal or the metal alloy contains at least sodium.

119. Axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section released by movement of the control piston, with a main flow direction, wherein the control piston has a guide face parallel to the main flow direction.

120. Axial-piston engine with a compressor stage comprising at least one cylinder, with an expander stage comprising at least one cylinder, with at least one combustion chamber between the compressor stage and the expander stage, with at least one control piston as well as a channel between the combustion chamber and the expander stage, wherein the control piston and the channel have a flow cross section released by movement of the control piston, with a main flow direction, wherein the control piston has an impact face perpendicular to the main flow direction.

121. Axial-piston engine wherein the movement of the control piston takes place along a longitudinal axis of the control piston, according to claim 119, wherein the control piston has a guide face at an acute angle to the longitudinal axis of the control piston.

122. Axial-piston engine wherein the movement of the control piston takes place along a longitudinal axis of the control piston, according to claim 120, wherein the control piston has an impact face at an acute angle to the longitudinal axis of the control piston.

123. Axial-piston engine according to claim 119, wherein the guide face and/or the impact face is a planar face, a spherical face, a cylindrical face or a conical face.

124. Axial-piston engine according to claim 120, wherein the guide face and/or the impact face is a planar face, a spherical face, a cylindrical face or a conical face.

125. Axial-piston engine according to claim 119, wherein the axial-piston engine has a guide-face sealing face between the combustion chamber and the expander stage, wherein the guide-face sealing face is formed parallel to the guide face and cooperates with the guide face at a top dead point of the control piston.

126. Axial-piston engine according to claim 120, wherein the axial-piston engine has a guide-face sealing face between the combustion chamber and the expander stage, wherein the guide-face sealing face is formed parallel to the guide face and cooperates with the guide face at a top dead point of the control piston.

127. Axial-piston engine according to claim 125, wherein the guide-face sealing face merges on the channel side into a surface perpendicular to the longitudinal axis of the control piston.

128. Axial-piston engine with at least one working cylinder, which is fed by a continuously working combustion chamber and which has an exhaust gas outlet, comprising a combustion chamber temperature sensor for determination of the temperature in the combustion chamber.

129. Axial-piston engine according to claim 128, wherein the combustion chamber temperature sensor determines a flame temperature in the combustion chamber.

130. Axial-piston engine according to claim 128, comprising a combustion chamber regulating system, which includes the combustion chamber temperature sensor as input sensor and regulates the combustion chamber so that the combustion chamber temperature is between 1,000° C. and 1,500° C.

131. Axial-piston engine according to claim 128, comprising an exhaust gas temperature sensor for determination of the exhaust gas temperature.

132. Axial-piston engine according to claim 131, wherein the combustion chamber regulating system includes the exhaust gas temperature sensor as an input sensor and regulates the combustion chamber in such a way that the exhaust gas temperature in an operating state is between 850° C. and 1,200° C.

133. Axial-piston engine according to claim 132, wherein the operating state is idling.

134. Axial-piston engine according to claim 128, wherein the combustion chamber temperature sensor is a precombustion chamber temperature sensor.

135. Axial-piston engine, wherein the stream of combustion agent from the combustion chamber to the working cylinder through a shot channel is controlled via at least one control piston, which, driven by a control drive, opens and closes the shot channel, wherein the control piston has opening and closing times that differ from one another.

136. Axial-piston engine according to claim 135, wherein the control piston is closed faster than opened.

137. Method for operation of an axial-piston engine with a compressor stage comprising at least one cylinder, with an expander stage comprising at least one cylinder, with at least one combustion chamber between the compressor stage and the expander stage, wherein a combustion agent is expanded during expansion in the expander stage with a greater pressure ratio than a pressure ratio existing during compression in the compressor stage.

138. Method for operation of an axial-piston engine according to claim 137, wherein the combustion agent is expanded in the expander stage approximately up to the pressure of an environment.
